(19) United States
(12) Patent Application Publication
(10) Pub. No.: US 2026/0107272 A1
(43) Pub. Date: Apr. 16, 2026

(54) ENHANCED DOWNLINK AND UPLINK COEXISTENCE TECHNIQUES FOR ELECTRONIC SHELF LABEL SYSTEMS

(71) Applicant: QUALCOMM Incorporated, San Diego, CA (US)

(72) Inventors: Varun Amar Reddy, San Diego, CA (US); Sony Akkarakaran, Poway, CA (US)

(21) Appl. No.: 18/916,379

(22) Filed: Oct. 15, 2024

(51) Int. Cl. H04W 72/1263; G06Q 10/109; H04W 72/51; H04W 72/566

(52) U.S. Cl. CPC H04W 72/1263; G06Q 10/109; H04W 72/51; H04W 72/566

(57) ABSTRACT

This disclosure provides systems, methods, and devices for Electronic Shelf Label (ESL) systems that support enhanced downlink and uplink positioning determination coexistence techniques. In a first aspect, a device for wireless communication includes at least one processor and a memory coupled to the at least one processor. The at least one processor is configured to cause the device to transmit schedule information for ESL devices. The at least one processor is also configured to cause the device to determine eTag transmission probability based on an eTag charging time and determine schedule change information based on the eTag transmission probability and the schedule information. The at least one processor is further configured to transmit the schedule change information to one or more ESL devices, one or more non-ESL devices, or both. Other aspects and features are also claimed and described.

### TECHNICAL FIELD

Aspects of the present disclosure relate generally to wireless communication systems, and more particularly, to electronic shelf label (ESL) systems. Some features may enable and provide improved communications and downlink and uplink coexistence, including flexible and low-power positioning determination for ESL systems.

### INTRODUCTION

In general, retail stores use paper labels to display information about products displayed on shelves, such as prices, discount rates, unit costs, origins, or the like. Using such paper labels for the price display has limitations. For example, when there are changes in product information or locations on shelves, the retailer must generate new paper labels and discard old ones. This raises costs for maintenance in both supplies and employee labor. Further, in environmental terms, replacing the labels wastes raw materials such as paper, which adversely affects the protection of the environment. Still further, humans are prone to make mistakes, such as mislabeling a shelf or product or forgetting to take down temporary price changes on certain shelving, which results in shopper frustration.

Electronic shelf label (ESL) devices are electronic devices for displaying price information for items on retail store shelves, which may be used in place of paper labels. ESL devices may be attached to a front edge of retail shelving and display a variety of pricing information using display devices, such as Liquid Crystal Displays (LCD). Whenever the information about a product or the location of a product is changed, the ESL device may be programmed with new product information. Thus, the electronic shelf label can be repeatedly used.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Electronic shelf label (ESL) devices may be used in a wireless network to provide information and services to shoppers and retailers (as users of an ESL system). For example, ESL devices operating on a wireless network as part of ESL system may support position location services to identify the location of ESLs devices within an environment (e.g., a retail store). As another example, the ESL system may support position location services to identify a position of users within the environment by interacting with the user's mobile device, non-ESL devices. Example embodiments provide for enhanced downlink and uplink positioning determination coexistence operations which enable a more flexible and adaptable scheme for utilize both uplink and downlink position determination techniques. The enhancements may utilize uplink transmission probability for determining scheduling adjustments for uplink and/or downlink position determination operations.

In one aspect of the disclosure, a device for wireless communication comprises: at least one processor; and a memory coupled to the at least one processor. The at least one processor is configured to cause the device to: transmit schedule information for electronic shelf label (ESL) devices; determine eTag transmission probability based on an eTag charging time; determine schedule change information based on the eTag transmission probability and the schedule information; and transmit the schedule change information to one or more ESL devices, one or more non-ESL devices, or both.

In another aspect of the disclosure, a method for wireless communication comprises: transmitting, by an electronic shelf label (ESL) server, schedule information for ESL devices; determining, by the ESL server, eTag transmission probability based on an eTag charging time; determining, by the ESL server, schedule change information based on the eTag transmission probability and the schedule information; and transmitting, by the ESL server, the schedule change information to one or more ESL devices, one or more non-ESL devices, or both.

In an additional aspect of the disclosure, a device for wireless communication comprises: at least one processor; and a memory coupled to the at least one processor. The at least one processor is configured to cause the device to: receive, from an electronic shelf label (ESL) server, schedule information for ESL devices; receive, from the ESL server, schedule change information based on eTag transmission probability; transmit at least a portion of the schedule change information to one or more ESL devices; and transmit at least a portion of the schedule change information to one or more non-ESL devices.

In an additional aspect of the disclosure, a device for wireless communication comprises: at least one processor; and a memory coupled to the at least one processor. The at least one processor is configured to cause the device to: receive, from an electronic shelf label (ESL) access point (AP), schedule information for ESL devices; receive, from the ESL AP, schedule change information based on eTag transmission probability; and transmit at least a portion of the schedule change information to one or more non-ESL devices.

In an additional aspect of the disclosure, a device for wireless communication comprises: at least one processor; and a memory coupled to the at least one processor. The at least one processor is configured to cause the device to: receive, from an electronic shelf label (ESL) device, schedule information for an ESL network; receive, from the ESL device, schedule change information based on eTag transmission probability; and transmit an uplink transmission based on the schedule change information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

Devices, networks, and systems may be configured to communicate via one or more portions of the electromagnetic spectrum. The present disclosure describes certain aspects with reference to certain communications technologies, such as Bluetooth or Wi-Fi. However, the description is not intended to be limited to a specific technology or application, and one or more aspects described with reference to one technology may be understood to be applicable to another technology. Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

For example, the described implementations may be implemented in any device, system, or network that is capable of transmitting and receiving RF signals according to any of the wireless communication standards, including any of the IEEE 802.11 standards, the IEEE 802.15.1 Bluetooth® standards, Bluetooth low energy (BLE), code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (5G NR), 6G, or other known signals that are used to communicate within a wireless, cellular, or internet of things (IOT) network, such as a system utilizing 3G, 4G 5G, or 6G technology, or further implementations thereof.

In various implementations, the techniques and apparatus may be used in wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably and may refer to a collection of devices capable of communicating with each other through one or more communications techniques.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.).

Implementations may range from chip-level or modular components to non-modular, non-chip-level implementations and further to aggregated, distributed, or original equipment manufacturer (OEM) devices or systems incorporating one or more described aspects. In some settings, devices incorporating described aspects and features may also include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, or constitutions.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a device is described as containing components A, B, or C, the device may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A is a block diagram illustrating an example Electronic Shelf Label (ESL) system according to some embodiments of this disclosure.

FIG. 1B is a diagram illustrating an example of ESL device display according to some embodiments of this disclosure.

FIG. 2A is a perspective view of a gondola with Electronic Shelf Label (ESL) devices according to some embodiments of the disclosure.

FIG. 2B is a top-down view of a retail environment with Electronic Shelf Label (ESL) devices accessible to a user according to some embodiments of the disclosure.

FIG. 3 is a timing diagram illustrating time division multiplexing for communicating with multiple Electronic Shelf Label (ESL) devices according to some embodiments of the disclosure.

FIG. 4 is a block diagram illustrating an example ESL device according to some embodiments of this disclosure.

FIG. 5 is a block diagram illustrating an example wireless communication system that supports enhanced downlink and uplink positioning coexistence operations according to one or more aspects.

FIG. 6 is a timing diagram illustrating an example process that supports enhanced downlink and uplink positioning coexistence operations according to one or more aspects.

FIG. 7 is a timing diagram illustrating an example process that supports enhanced downlink and uplink positioning coexistence operations according to one or more aspects.

FIG. 8 is a timing diagram illustrating an example process that supports enhanced downlink and uplink positioning coexistence operations according to one or more aspects.

FIG. 9 is a diagram illustrating an example of an ESL system that supports enhanced downlink and uplink positioning coexistence operations according to one or more aspects.

FIG. 10 is a timing diagram illustrating an example process that supports enhanced downlink and uplink positioning coexistence operations according to one or more aspects.

FIG. 11 is a flow diagram illustrating an example process that supports enhanced downlink and uplink positioning coexistence operations according to one or more aspects.

FIG. 12 is a flow diagram illustrating another example process that supports enhanced downlink and uplink positioning coexistence operations according to one or more aspects.

FIG. 13 is a flow diagram illustrating another example process that supports enhanced downlink and uplink positioning coexistence operations according to one or more aspects.

FIG. 14 is a flow diagram illustrating another example process that supports enhanced downlink and uplink positioning coexistence operations according to one or more aspects.

FIG. 15 is a block diagram of an example UE that supports enhanced downlink and uplink positioning coexistence operations according to one or more aspects.

FIG. 16 is a block diagram of an example ESL device that supports enhanced downlink and uplink positioning coexistence operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support enhanced Electronic Shelf Label (ESL) position determination and ESL position based notification operations. The enhanced ESL position determination operations support both uplink and downlink-based determination of device position within an ESL system based on ESL infrastructure, including for both ESL and non-ESL devices. For example, ESL devices or non-ESL devices (e.g., UEs) can determine a position for the non-ESL devices and/or eTags (electronic tags) based on ESL wireless transmissions. The present disclosure also supports enhanced downlink and uplink positioning coexistence operations that enable the ESL system to modify downlink and/or uplink positioning operations to improve utilization and reduce power consumption. For example, a schedule change may be determined for the ESL position determination operations based on transmission probability. The ESL determined position may then be used to determine and/or transmit notifications which enable automated monitoring of the ESL system and products thereof, and enable improved or additional functionality for users or ESL systems including improved automated task completion.

Particular implementations of the subject matter described in this disclosure may be implemented to realize one or more of the following potential advantages or benefits. In some aspects, the present disclosure provides techniques for the determination of uplink transmission probability for one or more devices (e.g., eTags) and for the adjustment of uplink and/or downlink operations based on the determined transmission probability. For example, the ESL system can modify the uplink and downlink position determination operations to enable UE devices to transmit uplink beacons and/or to have the ESL controllers refrain from transmitting downlink beacons to save power based on a determination that one or more uplink transmission resources may go unused. Thus, the ESL system can utilize uplink position based determination when uplink slots are not likely to be used (such as when eTags are charging) to save power of ESL devices, such as battery powered ESL controllers/radios. In some such aspects, the ESL system may be able to further group the ESL devices and make scheduling modification on a per group and/or area basis to further improve the uplink utilization and power reduction.

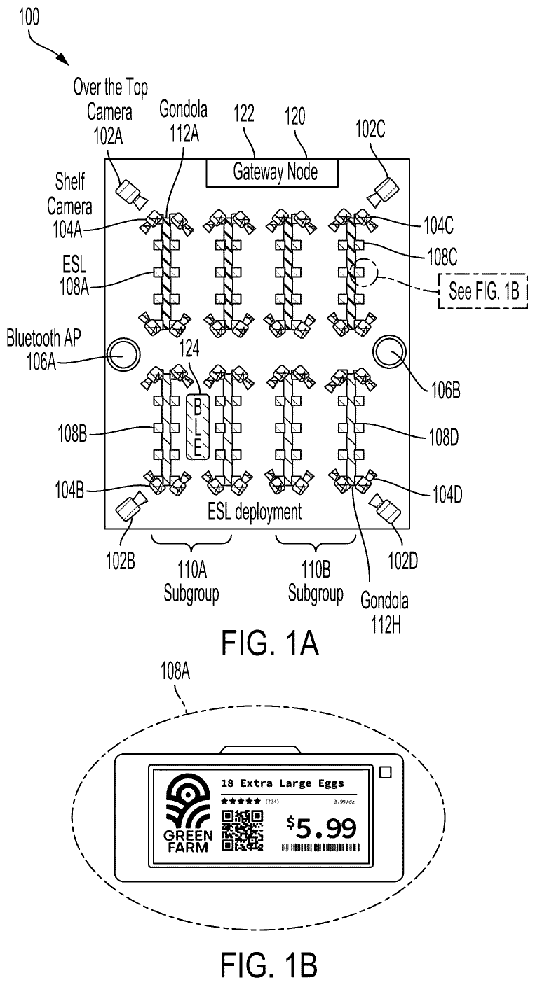

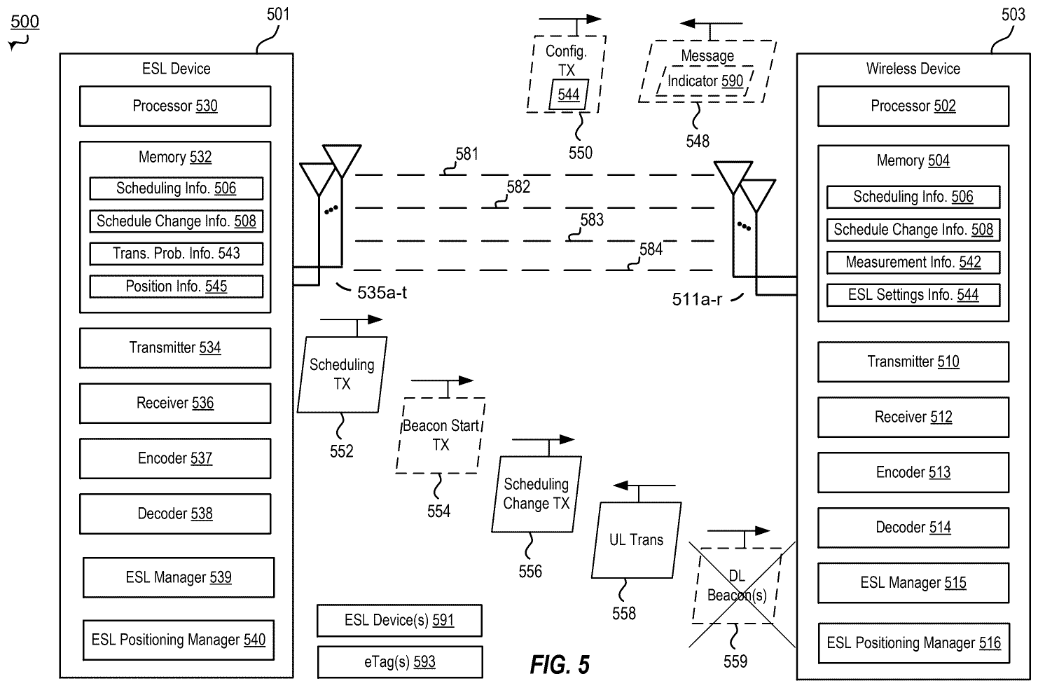

FIG. 1A is a block diagram illustrating an example Electronic Shelf Label (ESL) system according to some embodiments of this disclosure. An electronic shelf label (ESL) system 100 may include a management server 122 that is integrated with or coupled to a gateway node 120. The management server 122 may include at least one processor coupled to a memory, in which the at least one processor is configured to execute computer program code stored on a computer-readable medium to cause the management server 122 to perform operations related to managing operation of the ESL devices 108A-D, the APs 106A-106B, the gateway node 120, and/or other components within the ESL system 100. For example, the management server 122 may perform operations relating to ESL based position determination and/or generation of ESL notifications based on ESL based position determinations. For example, the management server 122 may perform enhanced downlink and uplink positioning coexistence operations described with reference to FIGS. 5-9.

The gateway node 120 may communicate with access point (AP) 106A and access point (AP) 106B. Although only two APs are shown in the example system, fewer or more APs may be included in the ESL system 100. The APs 106A and 106B may communicate through a first communication network, either wired or wireless, with the gateway node 120. The APs 106A and 106B also communicate through a second communication network with Electronic Shelf Label (ESL) tag devices. For example, the APs 106A and 106B may communicate with paired ESL devices in an assigned geographic area. In a first geographic assignment 110A, the AP 106A may communicate with ESL device 108A and ESL device 108B; in a second geographic assignment 110B, the AP 106B may communicate with ESL device 108C and ESL device 108D. The first and second communication networks may be different networks. In some embodiments, the first communication network for communication between AP 106A and gateway node 120 is a Wi-Fi network and the second communication network for communication between AP 106A and ESL device 108A is a Bluetooth network.

Bluetooth technology provides a secure way to connect and exchange information between electronic devices, such as smartphones, other cellular phones, headphones, earbuds, smartwatches, laptops, wearables, and/or shelf labels. Bluetooth communications may include establishing wireless personal area networks (PANs) (also referred to as “ad hoc” or “peer-to-peer” networks). These ad hoc networks are commonly called “piconets.” Each device may belong to multiple piconets. Multiple interconnected piconets may be called scatternets. A scatternet may be formed when a member of a first piconet elects to participate in a second piconet. In the example of FIG. 1A, the ESL device 108A may be in a piconet with the AP 106A.

Because many of the services offered over Bluetooth can expose private data or allow the connecting party to control the connected device, Bluetooth networks may have devices first establish a “trust relationship” before they are allowed to communicate private data to one another. This trust relationship may be established using a process referred to as “pairing,” in which a bond is formed between two devices. This bond enables the devices to communicate with each other in the future without further authentication. The ESL device 108A may be bonded in such a manner to the AP 106A. The pairing process may be triggered automatically each time the device is powered on or moved within a certain distance of another Bluetooth device. Pairing information relating to current and previously established pairings may be stored in a paired device list (PDL) in the memory of the Bluetooth device, such as the ESL device 108A and/or the AP 106A. This pairing information may include a name field, an address field, a link key field, and other similar fields (such as “profile” type) useful for authenticating the device or establishing a Bluetooth communication link. The pairing information may allow the ESL device 108A to reconnect to the AP 106A automatically when, for example, power loss causes the ESL system 100 to reset.

A Bluetooth “profile” describes general behaviors through which Bluetooth-enabled devices communicate with other Bluetooth devices. For example, the hands free profile (HFP) describes how a Bluetooth device (such as a smartphone) may place and receive calls for another Bluetooth device, and the Advanced Audio Distribution Profile (A2DP) describes how stereo-quality audio may be streamed from a first Bluetooth device (such as a smartphone) to another Bluetooth device (such as an earbud). The ESL devices 108A-108D may be configured with an Electronic Shelf Label Profile compliant with the Electronic Shelf Label Profile v1.0 dated Mar. 28, 2023, which is incorporated by reference herein. The ESL Profile may specify how the AP 106A may use one or more ESL Services exposed by the ESL device 108A.

The management server 122 may be implemented as a database (DB) server that stores and manages product information regarding products displayed in a distribution store. The management server 122 may store a variety of information used during the operation of a store, as well as product information. Furthermore, the management server 122 may write and manage command messages that are used to carry out various functions such as the synchronization, updating, and alteration of product information displayed on the ESL devices 108A-108D. The management server 122 may be provided with a database for the ESL devices 108A-108D and product information displayed on the ESL devices 108A-108D. That is, the management server 122 may be provided with a database that stores identification information relating to ESL devices 108A-108D in connection with product information displayed on a corresponding one of the ESL devices 108A-108D.

A command message, created by the management server 122 (e.g., a product-information change message or a management-information acquisition message) can be transferred to the gateway node using a message packaged into a packet suitable for a communication scheme used with the gateway node 120, and transfer the configured packet. Furthermore, the management server 122 may receive a reception acknowledgement message, sent from the gateway node 120, through the communication scheme, convert the received message into a message receivable by the management server 122, and transfer the converted message. The messages may include notifications of an ESL system determination position and/or notification instructions based on ESL determined positions as described further with reference to FIGS. 5-10.

Although only one gateway node 120 is shown in the ESL system 100, there may be several such gateway nodes communicating with the management server 122. Each gateway node 120 analyzes data received from the management server 122 confirming the presence or absence of a message or data, which is to be sent to the ESL device 108A, and then sends the confirmed message or data to the corresponding ESL device 108A. The gateway node 120 may configure a message, which is to be sent to the ESL device 108A, into a packet according to a communication scheme and send the configured packet to the ESL device 108A through commanding the AP 106A to transmit the packet. Furthermore, the gateway node 120 may transfer a reception acknowledgement message received from the ESL device 108A through the AP 106A to the management server 122.

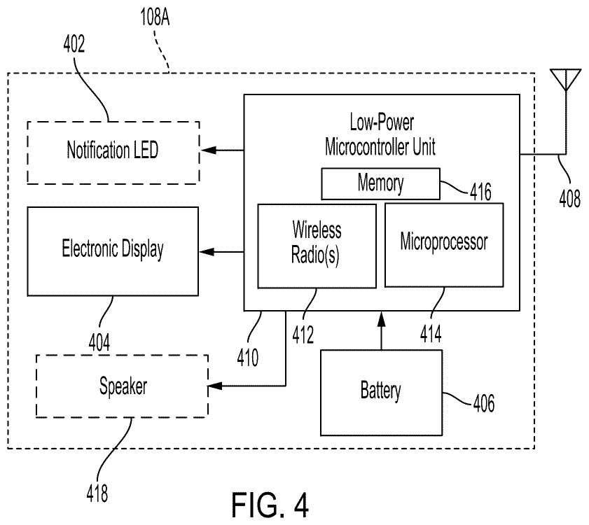

The ESL devices 108A-108D may include a plurality of ESL devices 108A-108D displaying data concerning product information received from the gateway node 120. The ESL devices 108A-D displaying product information associated with products may be attached to the shelving. One example layout of an ESL system 100 is shown across multiple gondolas 112A-112H. Each of the gondolas 112A-112H may include one or more shelves, to which the ESL devices 108A-108D are attached. The ESL device 108A-108D may be configured as shown, for example, in FIG. 4, with the microcontroller configured to perform operations described with reference to FIGS. 5-16.

In some embodiments, a video monitoring system may be included as part of ESL system 100 or used to augment the capabilities of the ESL system 100. For example, shelf cameras 104A-104D may be positioned with a field of view that captures one or more shelves of one or more of the gondolas 112A-112H. The shelf cameras 104A-104D may be used to assist in tracking stock levels and/or identifying items picked by users while in the environment. As another example, over-the-top (OTT) cameras 102A-102D may be positioned with a field of view capturing large regions of an environment of the ESL system 100. Object recognition systems may be applied to received image frames from the cameras 102A-D or 104A-D to determine a presence of, or count of, objects and humans in the field of view of a respective camera.

The OTT cameras 102A-102D may be used to support determination of a position of an ESL device 108A-D, user mobile device, or other devices within the environment. A mobile device supporting Bluetooth Low Energy (BLE), such as BLE device 124, may traverse the environment and communicate with the ESL devices 108A-108D, for example to receive identification information from the ESL devices 108A-108D, with the location of the ESL devices 108A-D determined by identifying a location of the BLE device 124 from the camera image frames at the time the BLE device 124 receives signals, and/or the strength of the signals, received from the ESL devices 108A-108D.

The ESL devices 108A-108D may change price information or be activated or inactivated while communicating with the gateway node 120. A store manager may send the management server 122 a command concerning the synchronization between a product and the ESL device 108A and/or a command for the correction of information regarding a product assigned to the ESL device 108A. An example ESL device display is shown inset in the FIG. 1B, with such a device displaying information including a product description, a product image, a product price, a product barcode, a product rating, a product Stock Keeping Unit (SKU), and/or a product link (e.g., a URL or QR code).

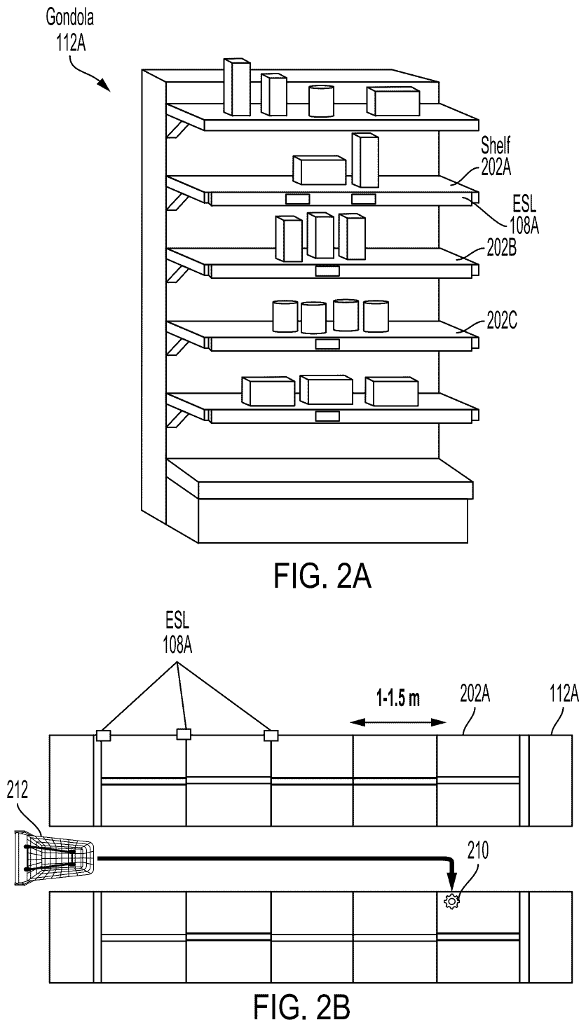

As described earlier, the environment may include ESL devices organized on gondolas and shelves. One example illustration of such an arrangement is shown in FIG. 2A. FIG. 2A is a perspective view of a gondola with Electronic Shelf Label (ESL) devices according to some embodiments of the disclosure. The gondola 112A may include multiple shelves 202A-202C at different vertical levels from a floor. ESL devices may be attached to the shelves 202A-202C. For example, ESL device 108A may be attached to shelf 202A to display information regarding products stocked on shelf 202A in the vicinity of the ESL device 108A.

The ESL devices may provide information to a shopper or store employee operating in the environment, such as to provide information regarding products and/or assist with location determination of products or the user. FIG. 2B is a top-down view of a retail environment with Electronic Shelf Label (ESL) devices accessible to a user according to some embodiments of the disclosure. A user pushing a shopping cart 212 through an aisle may use ESL devices to determine the location of a particular product. For example, a mobile device associated with the shopping cart 212 may guide a user to location 210 where stock for a desired product is located.

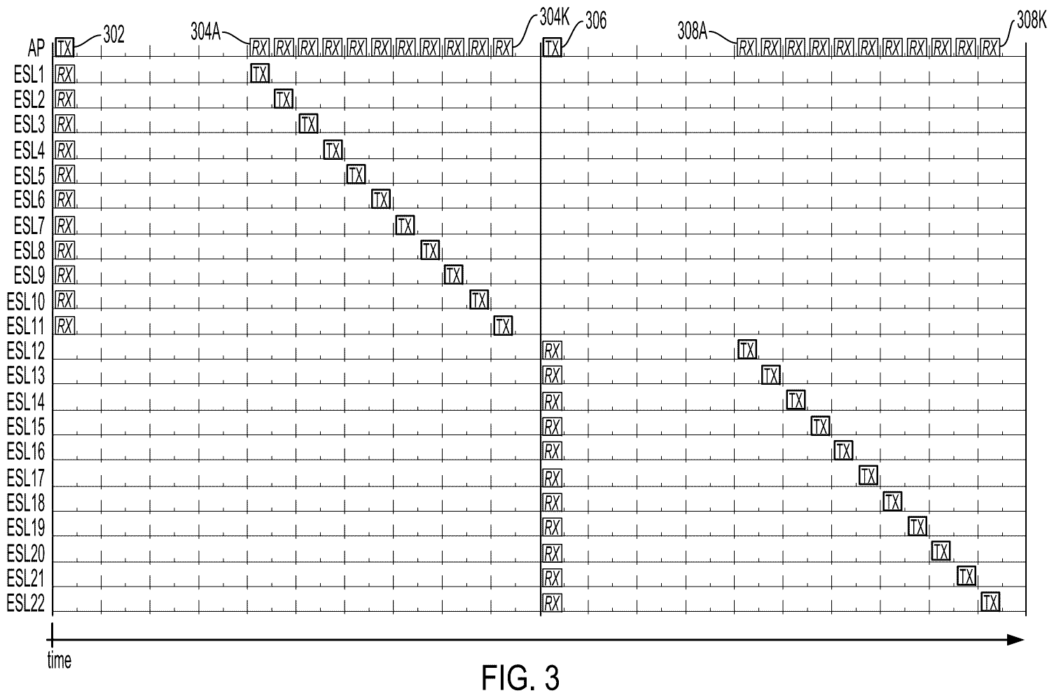

Communication within the ESL system 100 between an access point (AP) and Electronic Shelf Label (ESL) devices may be performed according to a Time Division Multiple Access (TDMA) scheme, such as one illustrated in FIG. 3. FIG. 3 is a timing diagram illustrating time division multiplexing for communicating with multiple Electronic Shelf Label (ESL) devices according to some embodiments of the disclosure. An AP, such as AP 106A, may broadcast information that is received by all ESL devices, including ESL device 108A, during a first time period 302. The ESL devices may communicate with the AP during subsequent time periods. For example, a first ESL device, such as ESL device 108A, may transmit in time period 304A, with other ESL devices transmitting in time periods 304B-304K. In ESL systems with significant numbers of ESL devices, the ESL devices may be configured to communicate in different groups. For example, ESL devices 1-11 may be configured to transmit to the AP during a first time cycle and ESL devices 12-22 may be configured to transmit to the AP during a second time cycle. The first and second time cycles may alternate during operation of the wireless network.

An ESL device may include components configured together to provide some or all of the functionality described in this disclosure and/or provide additional functionality. FIG. 4 is a block diagram illustrating an example Electronic Shelf Label (ESL) device according to some embodiments of this disclosure. The ESL device 108A may include a low-power microcontroller 410. Although functionality for the ESL device may be configured by the microcontroller 410 in embodiments of this disclosure, any single or combination of processors (e.g., at least one processor) may be used to perform the functions described according to embodiments of this disclosure.

The microcontroller 410 may include a memory 416. The memory 416 may store computer program code that causes a microcontroller 410 to execute operations that carry out some or all of the functionality described in embodiments of this disclosure. Although shown as part of the microcontroller 410, the memory 416 may be located internal to or external to the microcontroller 410. The microcontroller 410 may also include one or more wireless radio(s) 412. The wireless radios 412 may include, for example, a Bluetooth wireless radio including a front end that couples to antenna 408 for transmitting and receiving radio frequency (RF) signals at one or more frequencies in one or more frequency bands. In some embodiments, the microcontroller 410 is a System on Chip (SoC) in which two or more components of the wireless radio(s) 412, the microprocessor 414, and/or the memory 416 are included in a single semiconductor package. In some embodiments, the two or more components may be included on a single semiconductor die.

The ESL device 108A may include I/O devices, such as a notification LED 402 and/or an electronic display 404. The notification LED 402 may include one or more light emitting diodes (LEDs), or other light sources configured to flashlight of one or more colors. The notification LED may be triggered to blink at a specific time and/or with a specific color based on a command received from the gateway node 120. For example, a notification LED 402 may blink to attract a user's attention to a particular location on a shelf. The electronic display 404 may be, for example, an electronic-ink (e-Ink) display configured to output the product information. In some implementations, the ESL device 108A may include a speaker 418. The speaker 418 may include one or more audio output devices configured to output audio signals. For example, the speaker 418 may output tones, beeps, bell or chime sounds, or speech.

The ESL device 108A may couple to a battery 406 or other power source to power operations performed by the ESL device 108A, such as to operate the wireless radio(s) 412, the notification LED 402, the electronic display 404, the memory 416, the speaker 418, and/or the microprocessor 414. The battery 406 may allow placement of the ESL device 108A in a place where constant power supply is difficult. Thus, in order that a single battery charge provides a long period of use (e.g., lasting longer than several years), the ESL device 108 may be configured to reduce power consumption during times when frequent commands are not expected. For example, the ESL device 108A may operate using a wakeup communication scheme. That is, the ESL device 108A wakes up according to predetermined time intervals to determine whether data is waiting to be received. When no data is waiting, power to the ESL device 108A is turned off until the next wakeup period to reduce power consumption. When there is data to be received, the ESL device 108A wakes up to perform communication operations.

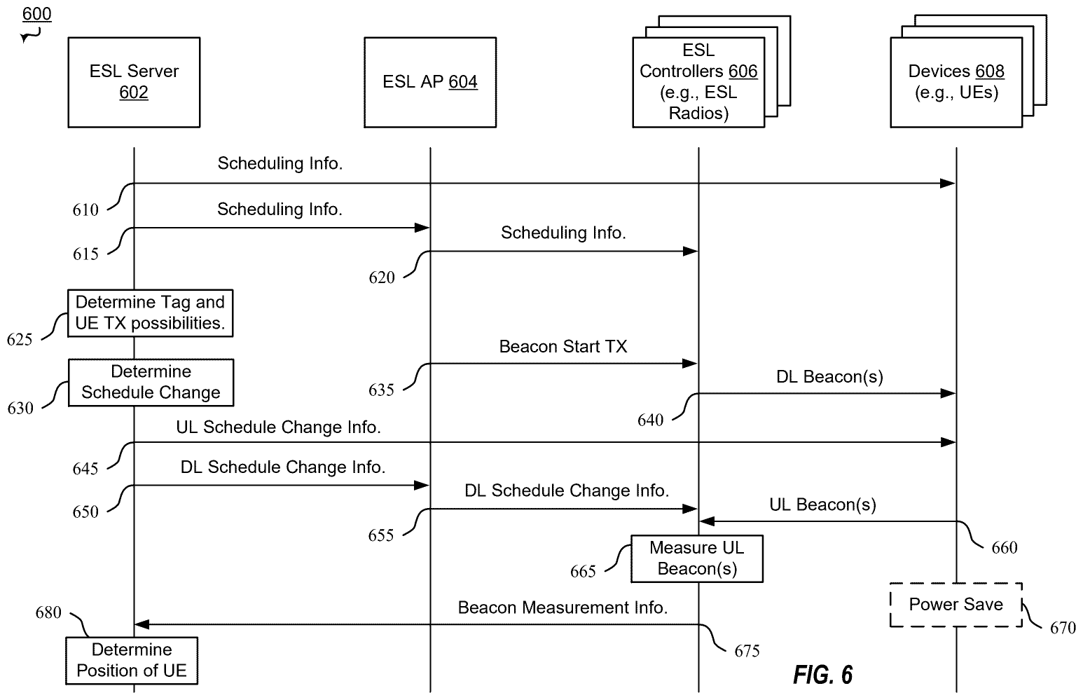

It is noted that one or more blocks (or operations) described with reference to FIGS. 1-4 may be combined with one or more blocks (or operations) described with reference to another of the figures. For example, one or more blocks (or operations) of FIG. 5 may be combined with one or more blocks (or operations) of FIGS. 1-4. As another example, one or more blocks associated with FIG. 6 may be combined with one or more blocks associated with FIGS. 1-4.

In certain scenarios, only Received Signal Strength Indicator (RSSI) measurements can be obtained by a device to estimate its position. Some examples of such scenarios include position estimation for or by low-cost devices or anchor node infrastructure which cannot perform other more complex measurements, such as more advanced strength or quality measurements, angle or arrival (AoA) measurements, or time of arrival (TOA) measurements that require advanced processing capability or hardware. Electronic Shelf Label (ESL) infrastructure is one such example and presents a highly-dense network of anchor nodes that can achieve sub-meter accuracy in retail-store settings, albeit with constraints on power consumption, because they are often battery-powered.

Enhanced downlink (DL)-based positioning schemes can modify or adapt the beaconing rate for an ESL radio based on its distance from a target device. Such a scheme would be compatible with mobile devices capable of decoding the ESL radios'beacons and measuring their RSSI. However, in order to determine a position for ambient IoT energy-harvesting eTags, which cannot decode ESL radio beacons, a different uplink (UL)-based positioning determination approach may be required where the ESL radios wake up to receive beacons from the eTags. To serve both types of devices (e.g., smartphones and eTags), a combination of both DL and UL schemes would have to be deployed. However, catering to both DL and UL positioning determining schemes would result in increased power consumption and lower battery life at the ESLs.

In the aspects described herein, enhanced DL and UL coexistence schemes are disclosed for enabling scheduling adjustments to DL and/or UL timing. The enhanced DL and UL coexistence schemes may include determining a probability for UL transmission for a particular UL time period, and then making one or more adjustments based on the determined probability. The scheduling adjustments enable reduced power consumption, reduced interference, and increased utilization with minimal overhead. In some aspects, the scheduling adjustments enable dynamic and opportunistic indications to mobile devices to transmit a beacon on the UL rather than making ESL radios transmit a beacon on the DL. In some such aspects, the mobile devices may utilize the UL time that is normally set aside for eTag transmissions when the determined probability for UL transmission satisfies one or more conditions. Additionally, ESL radio sub-grouping, device priority, and region-based schedule modifications may also be used to further enhance the benefits.

FIG. 5 illustrates an example of a wireless communications system 500 that supports enhanced downlink and uplink positioning coexistence operations and ESL position based notification operations in accordance with aspects of the present disclosure. In some examples, the wireless communications system 500 may implement aspects of ESL system 100. For example, the wireless communications system 500 may include an ESL network, such as ESL infrastructure including one or more ESL devices or network entities, and one or more wireless devices which interact with the ESL infrastructure. The wireless devices may include UEs. As illustrated in the example of FIG. 5, the wireless communications system 500 includes an ESL device 501 and a wireless device 503.

The ESL device 501 may include or correspond to any of the ESL devices or infrastructure described herein, including the gateway node 120, the management server 122, an ESL AP (e.g., the AP 106A or 106B), an ESL device or controller (e.g., ESL devices 108C or 108D), or the ESL device 400 of FIG. 4. An ESL controller may include one or more ESL devices and a wireless radio and be referred to as an ESL rail controller or more simply an ESL controller.

The wireless device 503 may include or correspond to a UE that interacts with ESL infrastructure, or to a second ESL device. The UE may be part of the ESL infrastructure or separate from the ESL infrastructure. For example, the UE may be associated with a worker or a robot, or with a customer/shopper. The second ESL device may include any of the ESL devices of ESL device 501 and may include or correspond to a different type of ESL device from the ESL device 501. As illustrative, non-limiting examples, the ESL device 501 may include or correspond to an ESL controller associated with one or more ESLs and the wireless device 503 may include or correspond to an ESL AP, an ESL server, or an IoT tag associated with a product or asset of the ESL network.

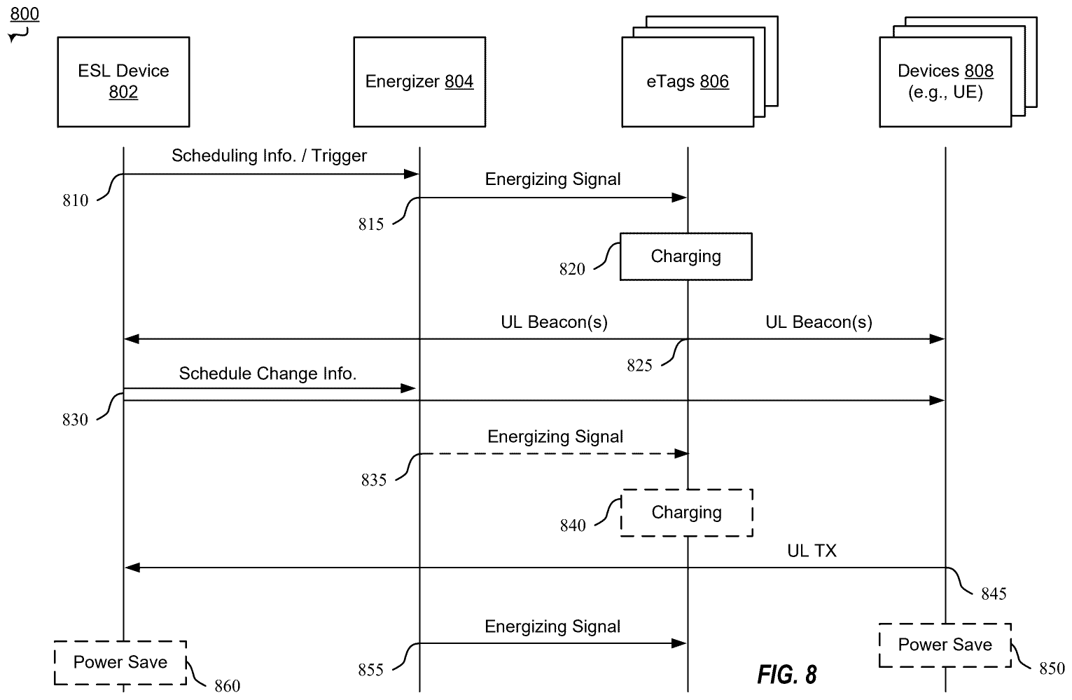

As illustrated in the example of FIG. 5, the wireless communications system 500 may further include one or more ESL devices 591 (e.g., second ESL devices), one or more electronic tags (eTags) 593 (e.g., IoT tags, ESL tags, etc.). The one or more ESL devices 591 may include or correspond to an ESL device which is the same type as or a different type from a type of the ESL device 501, a type of the wireless device 503, or both. The eTags 593 may include or correspond to passive or battery-less radios which may output a signal or beacon based on received RF energy. The eTags 593 may be coupled to or associated with one or more products or assets of the ESL system. In a particular implementation, the one or more ESL devices 591 may include an energizer device configured to provide RF energy to the eTags 593 and/or trigger the eTags 593 to broadcast beacons for measurement, as described further with reference to FIG. 8.

Enhanced ESL position determination coexistence operations and ESL position based notification operations may provide additional functionality for the ESL network and devices which interact with the ESL network. For example, enhanced ESL position determination coexistence operations may enable the ESL system to utilize more UL resources for UL transmissions and/or to conserve power by optionally refraining from DL beacon transmissions. Accordingly, ESL network and device performance can be increased.

ESL device 501 and wireless device 503 may be configured to communicate via one or more portions of the electromagnetic spectrum. For example, the ESL device 501, the wireless device 503, or both, may be configured to communicate via one or more portions of the electromagnetic spectrum associated with Bluetooth transmissions, Wi-Fi transmissions, or cellular transmissions (including sub-6 GHz and 6 GHz).

ESL device 501 and wireless device 503 may be configured to communicate via one or more channels or component carriers (CCs), such as representative first channel 581, second channel 582, third channel 583, and fourth channel 584. Although four channels are shown, this is for illustration only, more or fewer than four channels may be used. One or more channels may be used to communicate control channel transmissions, data channel transmissions, and/or sidelink channel transmissions.

Each channel or CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more channels or CCs may have or be assigned to a Cell ID, or a Bandwidth Part (BWP) ID. The Cell ID may include a unique cell ID for the channel or CC, a virtual Cell ID, or a particular Cell ID of a particular channel or CC of the plurality of channels or CCs. Additionally, or alternatively, one or more channels or CCs may have or be assigned to a HARQ ID. Each channel or CC may also have corresponding management functionalities, such as, beam management or BWP switching functionality. In some implementations, two or more channels or CCs are quasi co-located, such that the channels or CCs have the same beam and/or same symbol.

In some implementations, control information may be communicated via ESL device 501 and wireless device 503. For example, the control information may be communicated using Bluetooth transmissions, Wi-Fi transmission, MAC-CE transmissions, RRC transmissions, DCI (downlink control information) transmissions, UCI (uplink control information) transmissions, SCI (sidelink control information) transmissions, another transmission, or a combination thereof.

Wireless device 503 can include a variety of components (e.g., structural, hardware components) used for carrying out one or more functions described herein. For example, these components can include processor 502, memory 504, transmitter 510, receiver 512, encoder, 513, decoder 514, ESL manager 515, ESL positioning manager 516, and antennas 511a-r. Processor 502 may be configured to execute instructions stored at memory 504 to perform the operations described herein. In some implementations, processor 502 includes or corresponds to the microcontroller 410 and/or the microprocessor 414 of FIG. 4, and memory 504 includes or corresponds to the memory 416 of FIG. 4. Memory 504 may also be configured to store scheduling information 506, schedule change information 508, measurement information 542, ESL settings information 544, or a combination thereof, as further described herein.

The scheduling information 506 includes or corresponds to data associated with or corresponding to transmission timing information of the wireless communications system 500. For example, the scheduling information 506 may include data indicating or identifying transmission windows, such as UL and/or DL slots, transmit opportunities or both. The scheduling information 506 may optionally include grant information, such as transmission grants.

The schedule change information 508 includes or corresponds to data associated with or corresponding to a change in the transmission timing identified in the scheduling information 506. For example, the schedule change information 508 identify one or more UL slots for UL transmissions, one or more DL slots for power saving operations, or both. The schedule change information 508 may optionally include grant information, such as a modified transmission grant or a new transmission grant that correspond to a previous transmission resource associated with another device, such as an e-Tag.

The measurement information 542 includes or corresponds to data associated with or corresponding to measurements of wireless signals of the wireless communications system 500. For example, the measurement information 542 may include measurement data or measurement values associated with transmissions (e.g., Bluetooth or Wi-Fi transmissions) of the wireless communications system 500 and may enable the generation of position/location information. The measurement information 542 may include signal strength or quality measurements, such as reference signal received power (RSRP), reference signal received quality (RSRQ), RSSI, etc. Additionally, or alternatively, the measurement information 542 may include one or more of directionality information, such as AoA, timing information, such as TOA, or beam information.

The ESL settings information 544 includes or corresponds to data associated with enhanced ESL position determination operations and/or enhanced ESL position based notification operations. The ESL settings information 544 may include one or more types of enhanced ESL position determination operation modes and/or enhanced ESL position based notification operation modes and/or thresholds or conditions for switching between such enhanced modes and/or configurations thereof. For example, the ESL settings information 544 may have data indicating different thresholds and/or conditions for different enhanced ESL position determination modes and/or enhanced ESL position based notification modes, or a combination thereof.

Additionally, or alternatively, the ESL settings information 544 includes asset information, ESL device information, gondola information, store information, ESL transmission timing information (e.g., beacon timing information), UL and/or DL position determination modes, associated UE information, or a combination thereof.

Transmitter 510 is configured to transmit data to one or more other devices, and receiver 512 is configured to receive data from one or more other devices. For example, transmitter 510 may transmit data, and receiver 512 may receive data, via a network, such as a wired network, a wireless network, or a combination thereof. For example, wireless device 503 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 510 and receiver 512 may be replaced with a transceiver. Additionally, or alternatively, transmitter 510 or receiver 512 may include or correspond to one or more components of ESL device 108A described with reference to FIG. 4.

Encoder 513 and decoder 514 may be configured to encode and decode data for transmission. ESL manager 515 may be configured to perform enhanced downlink and uplink positioning coexistence operations. For example, the ESL manager 515 may be configured to manage one or more ESL related services, such as to generate ESL position based requests and process ESL notifications based on ESL based positions. The ESL manager 515 may be configured to generate ESL position based requests or request information based on measurement information, position information, time information, or a combination thereof.

ESL positioning manager 516 may be configured to perform ESL measurement and position determination operations. For example, the ESL positioning manager 516 may be configured to measure ESL transmissions (e.g., beacons) and determine measurement information based on ESL information and transmissions. As another example, the ESL positioning manager 516 may be configured to determine one or more positions of itself or other devices based on measurements of beacons and/or reference signal(s), the measurement information. Additionally, the ESL positioning manager 516 may be configured to determine position or location information of other ESL devices from ESL transmissions. The position information may be used to determine notification information.

In some implementations, the ESL positioning manager 516 may include or correspond to an ESL measurement manager may be configured to perform ESL position measurement and management operations. For example, the ESL measurement manager may be configured to measure received reference signals or beacons (e.g., beacons and/or beacon responses) to determine wireless information, measurement information, or both. The measurement information may be used to determine position information, such as position information 545.

Although one wireless device (i.e., wireless device 503) is shown in the example of FIG. 5, in other implementations the network may include additional wireless devices which interact with the ESL infrastructure (e.g., ESL device 501). The other wireless device or devices may include one or more elements similar to wireless device 503. In some implementations, the wireless device 503 and the other wireless device or devices are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc. As another example, one UE may be associated with a person and the other UE may be associated with a robot or autonomous device.

ESL device 501 includes processor 530, memory 532, transmitter 534, receiver 536, encoder 537, decoder 538, ESL manager 539, ESL positioning manager 540, and antennas 535a-t. Processor 530 may be configured to execute instructions stores at memory 532 to perform the operations described herein. In some implementations, processor 530 includes or corresponds to low-power microcontroller 410 and/or microprocessor 414, and memory 532 includes or corresponds to memory 416 of FIG. 4. Memory 532 may be configured to store schedule information 506, schedule change information 508, transmission probability information 543, position information 545, ESL settings information 546, or a combination thereof, and optionally other information such as described with reference to the wireless device 503 and as further described herein.

The transmission probability information 543 includes or corresponds to data associated with or corresponding to a likelihood of a device transmitting during a particular time period or for a particular transmit opportunity. The time period may include or correspond to a particular window or slot thereof. For example, the transmission probability information 543 may correspond to a likelihood of an e-Tag or eTags transmitting during a particular UL slot or Slots. The transmit opportunity may be associated with time resources, frequency resources, and/or a coding parameter. When determining a likelihood of a transmission during a transmit opportunity, the ESL device 501 may also take into account frequency resource and coding (e.g., orthogonality) when determining if transmission are likely to collide or cause interference (e.g., occupy the transmit resources). Additionally, the transmission probability information 543 may take into account spatial resource, such as the location and/or direction of the transmissions to determine the probability. The transmission probability information 543 may be expressed as a percentage and may optionally include a confidence value. The transmission probability information 543 may be used to determine the schedule change information 508 as described further herein.

The position information 545 includes or corresponds to data associated with or corresponding to a position of an ESL device, such as one of ESL devices 591 or eTags 593, a position of a non-ESL device, such as wireless device 503, or both. For example, the position information 545 may include data which indicates or identifies a position of a non-ESL device. To illustrate, the position information 545 may include positioning information which indicates a position of the device, i.e., position information, or positioning information which may be used to derive the position of the device, such as measurement information 542. The position information 545 may enable the generation of notifications (e.g., notification information, indications and/or instructions).

In some implementations, the position information 545 includes location information. The location information includes or corresponds to data associated with or corresponding to a location of an ESL device of the wireless communications system 500. For example, the location information may include data used for determining a location (e.g., measurement data), data indicating a location, data indicating formulas or methods for calculating a location, or a combination thereof. The location information may include or correspond to an initial or original position or location of ESL devices or ESL infrastructure of the wireless communications system 500. Additionally, or alternatively, the position information 545 includes or is derived from measurement information, such as measurement information 542.

Transmitter 534 is configured to transmit data to one or more other devices, and receiver 536 is configured to receive data from one or more other devices. For example, transmitter 534 may transmit data, and receiver 536 may receive data, via a network, such as a wired network, a wireless network, or a combination thereof. For example, UEs and/or ESL device 501 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 534 and receiver 536 may be replaced with a transceiver. Additionally, or alternatively, transmitter 534 or receiver 536 may include or correspond to one or more components of ESL device 108A described with reference to FIG. 4.

Encoder 537, and decoder 538 may include the same functionality as described with reference to encoder 513 and decoder 514, respectively. ESL manager 539 may be configured to perform enhanced ESL position based operations, and may include similar functionality as to ESL manager 515. For example, the ESL manager 539 may be configured to determine configure and/or coordinate ESL system operations, including UL and DL-based position determination operations. To illustrate, the ESL manager 539 may be configured to adjust a schedule of ESL operations to flexibly use both UL and DL-based position determination operations. In some aspects, the ESL manager 539 is configured to determine a transmission probability, such as the transmission probability information 543. The ESL manager 539 may then determine whether to perform a schedule change based on the transmission probability. For example, the ESL manager 539 may determine the schedule change information 508 based on the schedule information 506 and the transmission probability information 543. The ESL manager 539 may also use position information 545 to determine the schedule change and/or the transmission probability as described further with reference to FIGS. 6-9.

The ESL manager 539 may be configured to obtain initial ESL device position information indicating device positions of ESL devices, to generate and distributed ESL configuration or setup information, to transmit beacon start transmissions and/or beacon transmission, to generate schedule change information for the ESL system, or a combination thereof. As another example, the ESL manager 539 may be configured to determine ESL based positions for ESL devices or ESL assets and non-ESL devices and/or determine ESL notifications based on ESL based positions.

In some implementations, the ESL manager 539 may be configured to generate notifications or notification information based on measurement information, position information, request information, time information, or a combination thereof. The ESL manager 539 may include an ESL notification manager configured to perform ESL notification determination and management operations. For example, the ESL notification manager may be configured to generate and/or transmit enhanced ESL notifications, such as ESL notifications based on ESL based or determined positions. The ESL notification manager may be configured to determine notifications for assets, determine when and how to send the determined notifications, determine whether to send the determined notifications, or a combination thereof. Additionally, the ESL notification manager may be configured to generation instructions for causing other ESL devices and/or UEs to output notifications, such as visual or auditory outputs, to provide a notification, such as directions, to a user or a UE. In some implementations, the ESL notification manager may include a notification filter configured to filter the generation and/or transmission of notifications.

ESL positioning manager 540 may include similar functionality as described with reference to the ESL positioning manager 516. For example, the ESL positioning manager 540 may be configured to perform ESL position determination operations. To illustrate, the ESL positioning manager 516 may be configured to determine a position of a device (e.g., non-ESL device) based on ESL beacon transmission measurements (measurement information) from the device. The ESL positioning manager 516 may utilize the schedule change information to determine when and how to perform position determination operations, such as UL and/or DL-based position determination operations.

In some implementations, the ESL device 501 may include similar functionality as described with reference to the ESL manager 515, the ESL positioning manager 516, or both, of the wireless device 503. Additionally, or alternatively, the wireless device 503 may include similar functionality as described with reference to the ESL manager 539, the ESL positioning manager 540, or both, of the ESL device 501.

During operation of wireless communications system 500, the network (e.g., ESL device 501) may determine that wireless device 503 has ESL position determination and/or ESL position based notification capability. For example, wireless device 503 may transmit a message 548 that includes an ESL position determination and/or ESL position based notification indicator 590 (e.g., an enhanced downlink and uplink positioning coexistence indicator). Indicator 590 may indicate ESL position determination and/or ESL position based notification capability for one or more communication modes, such as uplink, downlink, sidelink, etc. In some implementations, an ESL network entity (e.g., the ESL device 501) sends control information to indicate to the wireless device 503 that enhanced ESL position determination coexistence operations and/or a particular type of enhanced ESL position determination coexistence operation is to be used. For example, in some implementations, configuration transmission 550 is transmitted to the wireless device 503. The configuration transmission 550 may include or indicate to use enhanced ESL position determination coexistence operations or to adjust or implement a setting of a particular type of enhanced ESL position determination coexistence operation. For example, the configuration transmission 550 may include schedule information 506 or ESL settings information 544.

During operation, devices of wireless communications system 500 perform enhanced downlink and uplink positioning coexistence operations. For example, the ESL network and wireless devices may exchange transmissions via uplink, downlink, and/or sidelink communications over the communication links and engage in enhanced ESL position determination coexistence operations, as illustrated in the example of FIG. 5. Enhanced ESL position determination coexistence operations enable improved flexibility and utilization of resources, such as uplink resources, and the ability to use both uplink and downlink-based position determination operations. The enhanced ESL position based notification operations enable ESL devices and/or wireless devices to have reduced power consumption through utilization of additional uplink resources and reducing redundant downlink operations.

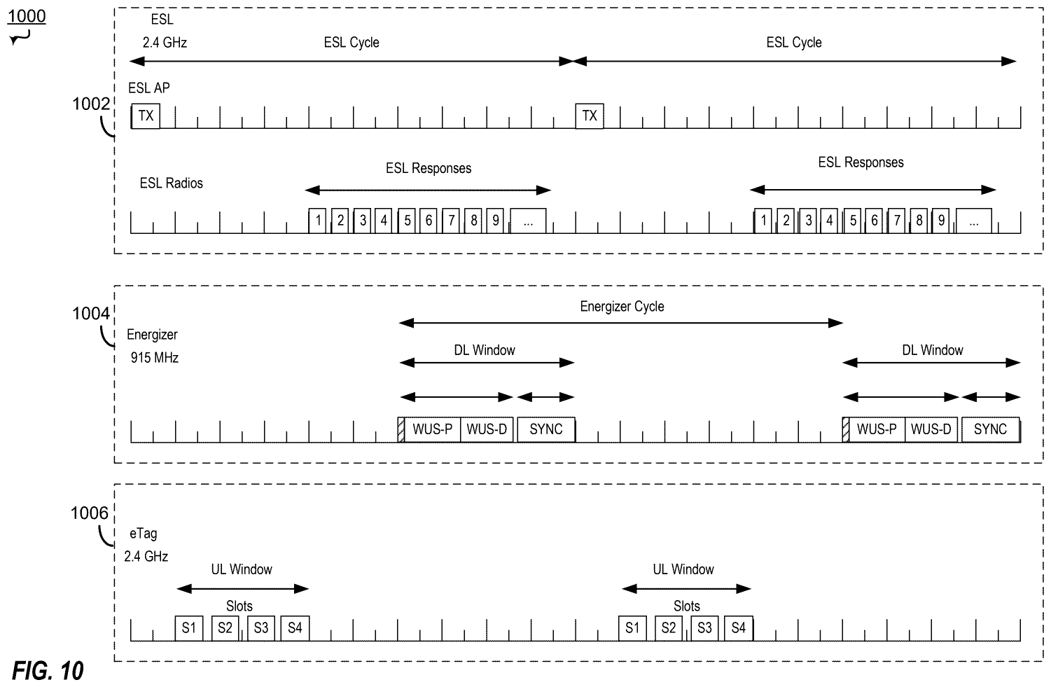

In the example of FIG. 5, the ESL device 501 generates the scheduling information 506 for transmission in a configuration, timing, or scheduling transmission, such as scheduling information transmission 552. For example, the ESL device 501 may generate overall ESL timing related parameters and information for scheduling beacon transmissions, including for scheduling or performing DL and UL-based position determination operations. To illustrate, the ESL device 501 may generate timing information relative to beacon start transmissions and/or energizing transmissions, such that the receiving devices can utilize this information along with received trigger transmissions to determine when to transmit, and may generally provide the information for uplink and downlink transmission timing schemes such as described with reference to FIG. 3 and further with reference to FIG. 10. Additionally, or alternatively, the scheduling information 506 may include one or more UL or DL grants from one or more devices that are associated with the ESL system. The scheduling information 506 may be transmitted in multiple ways in some aspects. For example, the scheduling information 506 may be transmitted via a local wireless network or protocol (e.g., Wi-Fi or Bluetooth) to ESL devices and may be transmitted via another network or protocol (e.g., cellular) to non-ESL devices. In other examples, the scheduling information 506 may be transmitted via the local wireless network or protocol (e.g., Wi-Fi or Bluetooth) to ESL and non-ESL devices.

As illustrated in the example of FIG. 5, the ESL device 501 transmits the scheduling information transmission 552, including the scheduling information 506, via wireless transmission to one or more ESL device, one or more non-ESL devices, or a combination thereof. Examples of scheduling information 506 generation and transmission are described further with reference to FIGS. 6-10, and may include an ESL server, ESL AP, or ESL controller receiving ESL based position information from and determined by a UE.

ESL devices of the network, such as the ESL device 501, periodically transmit beacons, such as described with reference to FIG. 3, and further with reference to FIGS. 6-9. The beacons may be used by ESL and non-ESL devices to determine a relative position from the ESL devices or a position within an ESL system, such as for DL positioning estimation when the devices or ESL controllers/radios transmit the beacons and the beacons are received by the wireless device 503. Additionally, the wireless device 503 or eTags 593 may transmit beacons which are measured by other ESL devices for use in UL positioning estimation.

In some aspects, the beacons transmitted by ESL devices and/or the wireless device 503 may be initiated by a beacon start transmission, such as the optional beacon start transmission 554. The beacon start transmission 554 may be optionally sent by an ESL device, such as an ESL AP, and the beacon start transmission 554 may trigger beacons to be transmitted and monitored for by other devices according to or based on the scheduling information 506.

However, in ESL systems the e-Tags 593 tags may move in and out of the ESL system and around through the ESL system. These e-Tags 593 may transmit in response to being charged from external devices. Based on their placement and distance from the external charging devices, referred to as energizers, the e-Tags 593 may have drastically different charging times. Accordingly, the e-Tags 593 may not transmit in every UL slot in a given UL window and may not even transmit in every UL window. Thus, a large portion of UL bandwidth may go unused. Additionally, even if the e-Tags 593 are transmitting in a window or slot, there may be unused transmit resources, such as UL transmit opportunities that may be available, such as combinations of time, spatial, frequency, and/or coding resources.

In the aspects described herein, the ESL device 501 may determine a schedule change for the ESL devices and/or non-ESL devices to better utilize the UL bandwidth. For example, the ESL device 501 may determine an eTag transmission probability and determine a schedule change on the determined eTag transmission probability. To illustrate, the ESL device 501 determines a likelihood of a particular e-Tag transmitting during a particular UL window or UL slot of the window. The ESL device 501 may repeat this for all e-Tags 593 or a subset of e-Tags 593 in a region and/or on a slot or transmit opportunity basis to determine an overall likelihood of transmission during the slot or transmit opportunity. When the likelihood satisfies a threshold value, the ESL device 501 may determine a schedule change can be made, such as when the determined possibility is below a threshold value and/or when the determined possibility has a particular confidence value above a second threshold value.

The likelihood of a particular e-Tag transmitting may be determined based on a charging time of the e-Tag, a backoff parameter associated with the e-Tag, or both. For example, the ESL device 501 may know the backoff scheme and/or a programmed backoff parameter, such as Q-value, for the e-Tag which can be used to ascertain when in the window the e-Tag is likely to transmit if at all. Additionally, or alternatively, the ESL device 501 may determine an anticipated charging time based on history of transmissions and/or charging times for the e-Tag, based on a position of the e-Tag, based on a position of nearby Energizer devices, or a combination thereof. As the charging time for an e-Tag is correlated to its distance from charging signals, the charging time after a prior transmission by the e-Tag can be accurately estimated based on one or more of the above parameters. In some aspects, the ESL device 501 may use an AI/ML model to determine the likelihood of transmission and/or a confidence value in that likelihood for an e-Tag or region and for a particular time period or transmit opportunity.

In some aspects, the ESL device 501 may determine the schedule change further based on a region or area associated with the eTag transmission probability. For example, the ESL device 501 may determine an area or region for each e-Tag or group of e-Tags and may assess the likelihood of transmission for that particular area and time. Additional details for eTag transmission determination are described further with reference to FIGS. 6-9.

After determination of the schedule change, the ESL device 501 generates schedule change information 508 and transmits a schedule change transmission 556 including the schedule change information 508 to one or more ESL devices, one or more non-ESL devices, or both. For example, the ESL device may transmit the schedule change transmission 556 to one or more non-ESL devices, such as the wireless device 503 in the example of FIG. 5, to enable one or more of the non-ESL devices to transmit uplink transmission (e.g., notification request or beacon), and optionally to perform a power save operation (e.g., enter a lower power state). To illustrate, as the non-ESL device may have utilized an unused UL slot (e.g., a slot not used by an e-Tag) or transmit opportunity to send an uplink transmission (e.g., notification request or beacon), the ESL devices can measure that uplink transmission 558 for position estimation for the non-ESL device, and the non-ESL does not need to stay awake to monitor for and receive a DL beacon, such as DL beacon 559, for the non-ESL device to measure for position determination.

As another example, the ESL device 501 may transmit the schedule change transmission 556 to one or more ESL devices to enable the devices to refrain from transmitting a beacon transmission, and optionally to perform a power save operation (e.g., enter a lower power state). To illustrate, as the non-ESL device may have utilized the unused UL slot or transmit opportunity to send an uplink transmission (e.g., notification request or beacon), the ESL devices can measure that uplink transmission 558 for position estimation for the non-ESL device and do not need to transmit a DL beacon, such as DL beacon 559, for the non-ESL device(s) to measure.

Although one schedule change is illustrated in the example of FIG. 5, the ESL device 501 may generate multiple schedule changes for different devices and/or different regions to better utilize the UL bandwidth of the ESL system. The increased usage of UL bandwidth, and the transmissions therein, can also be used to perform UL-based position determination operations and to refrain from performing redundant DL-based position determinations, including refraining from transmitting DL beacons.

Additional examples of schedule change operations, including descriptions and examples for usage of the determined position information, are described further with reference to FIGS. 6-10. For example, generation of notifications, transmission of notifications, and illustrative examples of notifications are described further with reference to FIGS. 6-10.

Accordingly, the network (e.g., the ESL device 501 and the wireless device 503) may be able to perform enhanced downlink and uplink positioning coexistence operations, and optionally ESL position based notification operations. Accordingly, the ESL network performance and ESL network and user experience may be increased due to enhanced ESL system capabilities based on ESL based positions and notifications and reduced power consumption.

Referring to FIG. 6, FIG. 6 is a timing diagram 600 illustrating an ESL system that supports UL and DL schedule modifications according to one or more aspects. The example of FIG. 6 corresponds to an example of enhanced downlink and uplink coexistence by UL and DL schedule modifications. The example FIG. 6 may enable improved determination of ESL based positions (e.g., a position within or with reference to an ESL system or ESL infrastructure) for external devices based on signals and information received one or more ESL infrastructure devices by increasing UL utilization and reducing power consumption.

In the example of FIG. 6, the ESL system includes an ESL server 602, an ESL AP 604, ESL controller(s) 606 (e.g., ESL radios), and device(s) 608 (e.g., UEs). The ESL controller(s) 606 may each include or correspond to an ESL with a wireless radio or a wireless device/radio associated with a plurality of ESLs. Although one ESL AP is illustrated, the ESL system may include multiple ESL APs, each serving multiple ESL controllers and devices.

Prior to 610, the ESL system may be configured with initial position information and/or configurations for network operation and positioning determination operations. For example, an operator may setup or preconfigure the system with initial positions for one or more devices and/or assets of the ESL systems. To illustrate, one or more of ESL APs, ESL controllers, ESLs, or assets (which may be tagged with an IoT tag) may be configured with an initial position. As another example, the ESL system may enter, such as upon initial setup, reconfiguration, or periodically (e.g., nightly weekly, monthly, quarterly, etc.), a measurement mode to determine initial or updated positions.

For example, the ESL server 602 may transmit configuration information (e.g., the configuration transmission 550 or the ESL settings information 546 of FIG. 5) to the ESL AP 604 and the ESL controllers 606. To illustrate, the ESL server 602 may transmit the configuration information directly to each device, such as by broadcast transmission or direct transmission, or the ESL server 602 may transmit the configuration information to ESL AP 604, which then transmits or relays then configuration information to one or more ESL devices, such as the ESL controllers 606. In an illustrative, non-limiting example, the ESL server 602 may transmit the configuration to ESL AP 604 via a wired connection, and the ESL AP 604 may unicast or broadcast the configuration information to the ESL devices and non-ESL devices.

As described above, the configuration information may include information configured to enable scheduling and timing coordination. For example, the configuration information may include UL and DL slot timing information for the difference devices or types/groups of devices.

Additionally, or alternatively, initial position information may be transmitted in the configuration information. For example, the operator may input a position into the ESL controllers 606, and the ESL controllers 606 may relay that position to the ESL server 602 via the ESL AP 604. As another example, the operator may configure the ESL server 602 with the position of the ESL controllers 606, which is then relayed to the ESL controllers 606 via the ESL AP 604. As yet another example, each of the ESL controllers 606 determines its position based on a beacon of the ESL AP 604, and transmits its determined position to the ESL server 602.

At 610, the ESL server 602 may transmit scheduling information to the devices 608 for participation in the ESL system. For example, the ESL server 602 may unicast or broadcast a transmission to one or more external devices, including the devices 608 (e.g., UE), which indicates or includes ESL scheduling information, such as the scheduling information 506 of FIG. 5. The devices 608 may utilize the ESL scheduling information to determine UL slots for transmission of uplink transmissions (e.g., beacons or ESL requests), DL slots for reception of DL transmission (e.g., beacons for measurement or beacon start transmissions/timing transmissions), or both.

At 615, the ESL server 602 may transmit scheduling information to the ESL AP 604 for relay to other ESL devices. For example, the ESL server 602 may unicast or broadcast a transmission to one or more ESL APs, including the ESL AP 604, which indicates or includes ESL scheduling information, such as the scheduling information 506 of FIG. 5. The ESL AP 604 may utilize the ESL scheduling information to determine UL slots for receiving UL transmissions (e.g., beacons or ESL requests), DL slots for transmitting DL transmission (e.g., beacons for measurement or beacon start transmissions/timing transmissions), or both.

At 620, the ESL AP 604 may transmit scheduling information to one or more ESL controllers/devices, including the ESL controllers 606. For example, the ESL AP 604 may relay the scheduling information or transmit ESL controller scheduling information based on the received scheduling information. The ESL AP 604 may transmit the scheduling information by unicast or broadcast a transmission to the one or more ESL controllers/devices. The one or more ESL controllers/devices, including the ESL controllers 606, may utilize the ESL scheduling information to determine UL slots for receiving UL transmissions (e.g., beacons or ESL requests), DL slots for transmitting DL transmission (e.g., beacons for measurement or beacon start transmissions/timing transmissions), or both.

At 625, the ESL server 602 may determine uplink transmit possibilities. For example, ESL server 602 may determine uplink transmit possibilities for one or more eTags, one or more devices, or both, for one or more UL slots or transmit opportunities, such as transmission probability information 543 of FIG. 5. To illustrate, the ESL server 602 may estimate or infer the possibility of a particular eTag transmitting during a particular uplink slot or slots (e.g., over an uplink window) and optionally for a particular transmit opportunity thereof. When determining the possibility of a particular eTag transmitting during a particular uplink window or transmit opportunity, the ESL server may utilize an anticipated charging time for the eTag, a backoff parameter (e.g., Q-value) of the eTag, and/or a transmission history (e.g., transmission history information) for the eTag. In some implementations, the ESL server 602 may determine the possibility that an eTag of a plurality eTags will transmit during a particular uplink window or particular transmit opportunity thereof. In such implementations, the ESL server 602 may further utilize the number of eTags in a particular region. The particular region may correspond to or be associated with one or more external devices (e.g., non-ESL infrastructure devices), such as one or more of the devices 608.

Regarding the above parameters, the anticipated charging time may correspond to or be based on a signal strength of an energizing signal received at the eTag. The signal strength of the energizing signal received at the eTag corresponds to charging time well and can be mapped to a charging time using a charging time and distance curve. The known or expected energizing signal strength/coverage (e.g., expected RSSI) may be known beforehand in a certain area. Alternatively, a previous beacon from an eTag may contain the RSSI (of the energizing signal) that was measured by the eTag. The Q-value corresponds to a parameter that an eTag uses to determine its backoff time for beacon transmissions, as further described with reference to FIG. 10. The Q-value of the eTag is known by the ESL network (e.g., set by the ESL server 602) and can be used to determine an average or expected backoff time for a subsequent beacon transmission. The number of eTags can be used to determine a likelihood that an eTag will transmit and a higher number of eTags in a region would lead to a higher probability of an UL transmission and the UL slot or window being occupied.

In some aspects, the ESL server 602 may use AI/ML techniques to determine the likelihood of a transmission by an eTag or a plurality of eTags. For example, the ESL server 602 may utilize a received model or may train a model based on historic eTag transmissions to determine a likelihood of a future transmission.

Similarly, the ESL server 602 may also determine a likelihood of a transmission by the devices 608 using any of the above described techniques with respect to eTags. For example, the ESL server 602 may determine a likelihood of a transmission by a particular UE of the devices 608 based on a history of UL transmissions (e.g., UL beacons, ESL notification requests, etc.), a number of devices, a time since last UL transmission, etc. After the likelihood of a future transmission is determined for one or more devices, such a possibility of future transmission and a confidence value in the possibility, the output value or values may be evaluated to determine if a schedule change is to be made.

At 630, the ESL server 602 may determine a schedule change based on the determined uplink transmit possibilities. For example, the ESL server 602 may determine an UL schedule change, a DL schedule change, or both based on the determined uplink transmit possibilities, such as based on schedule change information generated based on the determined uplink transmit possibilities. To illustrate, the ESL server 602 may utilize one or more conditions, such as one or more thresholds, to evaluate the determined likelihood of uplink transmissions to generate the schedule change information, such as schedule change information 508. For example, the ESL server 602 may include a percentage UL transmission threshold, a number of UL transmissions threshold, a confidence value threshold, etc., as illustrative, non-limiting examples. Alternatively, the ESL server 602 may use an AI/ML model to determine whether to implement a schedule change, and optionally, to determine the particular schedule change (e.g., which slot or slots to reschedule or repurpose and/or which transmit opportunities thereof).

In some aspects, the ESL server 602 may determine whether to make an UL schedule change based on the determined uplink transmit possibilities, and then may determine to make a DL schedule change based on the determination to make the UL schedule change or based on a determination that the repurposed or rescheduled UL slots were actually used. In other aspects, the ESL server 602 may determine whether to make UL and DL schedule changes based on the determined uplink transmit possibilities. For example, DL slots corresponding to uplink slots identified as available (e.g., low likelihood of eTag transmission or low number of eTag transmissions), may also be rescheduled or repurposed.

At 635, the ESL AP 604 may initiate beacon transmissions by ESL devices. For example, the ESL AP 604 may transmit a beacon start transmission, such as the broadcast transmission at 302 of FIG. 3. To illustrate, the ESL AP 604 may broadcast a transmission which is configured to cause ESL controllers, including ESL controllers 606, to transmit DL beacon transmissions, cause devices (e.g., devices 608) to measure the DL beacon transmissions, cause devices (e.g., devices 608) to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet.

At 640, the ESL controllers transmit one or more DL beacons. For example, one or more ESL controllers, including the ESL controllers 606, transmit a DL beacon during a first DL slot or window based on the scheduling information. The first DL slot or window may include or correspond to an originally scheduled DL slot or window. For example, the first DL slot or window may have originally been scheduled, assigned, or otherwise reserved for DL transmissions by the ESL controllers. The ESL controllers may determine the timing of the DL beacon based on both the scheduling information and the beacon start transmission (e.g., the transmission or reception time thereof).

Although the UL schedule change information and DL schedule change information are illustrated in different transmissions in the example of FIG. 6, such may be included in the same transmission in other examples. For example, in some implementations the beacon start transmissions sent by the ESL APs, such as ESL AP 604, may include or indicate the UL schedule change information, the DL schedule change information, or both.

At 640, the ESL controllers transmit beacons responsive to the beacon start transmission (e.g., beacon frame or synchronization transmission). For example, one or more of the ESL controllers 606 each transmit a beacon (beacon transmission) responsive to the beacon start transmission from the ESL AP 604. To illustrate, a first ESL controller of the ESL controllers 606 broadcasts a first beacon after a first delay from the beacon start transmission, and a second ESL controller thereof broadcasts a second beacon after a second delay from the beacon start transmission, etc., in a TDMA fashion, similar to the operations of FIG. 3. The beacon transmissions may include or correspond to Bluetooth transmissions and may correspond to responses to synchronization packets. Although a beacon start transmission and DL beacons are illustrated as being transmitted in the example of FIG. 6, such may correspond to a previous cycle and not a cycle where the ESL server 602 has determined a UL schedule change in some aspects. In other aspects, the beacon start transmission and/or DL beacons may correspond to an ESL cycle where an UL schedule change has been determined and a beacon start and/or one or more DL beacons may be transmitted as illustrated in FIG. 6. In some such aspects, one or more other beacon start or DL beacon transmissions may not be transmitted, such as for a particular region or ESL group.

At 645, the ESL server 602 may transmit UL schedule change information to one or more of the devices 608 for enhanced UL and DL coexistence operations. For example, the ESL server 602 may unicast or broadcast a transmission to one or more ESL APs, including the ESL AP 604, which indicates or includes the schedule change information, and the ESL AP 604 then relays the schedule change information to one or more the devices 608, such as by Wi-Fi or Bluetooth transmission. Alternatively, the ESL APs transmit device or group specific UL schedule change information to specific devices or groups of devices based on the received UL schedule change information. To illustrate, only certain areas of the ESL system may be affected by the change and only the applicable ESL APs and controllers may receive and transmit the UL schedule change information for the affected devices. As another example, the ESL server 602 may transmit the schedule change information to the devices 608 via another wireless network, such as a cellular network, or via the Internet.

As described herein, the schedule change information transmitted to the devices 608 may include or correspond to UL only schedule information or combined UL and DL schedule change information. In some aspects, the devices 608 may infer DL changes, such as to perform a power save operation for particular DL slots, based on explicitly indicated uplink changes in UL only schedule change information. As described further herein, the schedule change information enables one or more of the devices 608 to engage in UL-based position determination operations, and such may enable one or more ESL devices to refrain from engaging in DL-based position determination operations to save power.

At 650 and 655, the ESL server 602 may transmit DL schedule change information to the ESL devices for enhanced UL and DL coexistence operations. For example, the ESL server 602 may unicast or broadcast a transmission to one or more ESL APs, including the ESL AP 604, at 650 and which indicates or includes the DL schedule change information, and the ESL AP 604 then relays the DL schedule change information to the ESL controllers, including ESL controllers 606 at 655, such as by Wi-Fi or Bluetooth transmission. Alternatively, the ESL APs transmit device or group specific DL schedule change information to specific ESL controllers or groups of controllers based on the received DL schedule change information. To illustrate, only certain areas of the ESL system may be affected by the change and only the applicable ESL APs and ESL controllers may receive and transmit the schedule change information from the ESL server and ESL APs respectively. As described herein, the schedule change information transmitted to the controllers 606 may include or correspond to DL only schedule information or combined UL and DL schedule change information. In some aspects, the ESL controllers 606 may infer UL changes, such as to monitor one or more UL slots, based on explicitly indicated downlink changes in DL only schedule change information.

Additionally, the ESL server 602 may transmit DL schedule change information to the devices 608 for enhanced power save operations in some implementations. For example, the ESL server 602 may transmit the DL schedule change information with the UL schedule change information or via one of the distribution methods described with reference to the UL schedule change information above. As another example, the devices 608 may receive the DL schedule change information via beacon type transmissions from the ESL APs or ESL controllers, similar to how ESL controllers receive the DL schedule change information.

At 660, one or more of the devices 608 transmit one or more UL beacons. For example, at least one device of the devices 608 transmits an UL beacon during a first UL slot or window, or a particular uplink transmit opportunity thereof, based on the UL schedule change information. The first UL slot or window may include or correspond to a rescheduled or a repurposed UL slot or window or a rescheduled or a repurposed uplink transmit opportunity thereof. For example, the first UL slot or window may have originally been scheduled, assigned, or otherwise reserved for UL transmissions by other ESL devices, such as eTags, (e.g., eTag UL beacons) or other external devices. The devices 608 may determine the timing of the UL beacon based on both the scheduling information and the UL schedule change information. Additionally, or alternatively, the devices 608 may further determine the timing of the UL beacon based on the DL schedule change information.

At 665, the ESL controllers of the ESL system receive one or more UL beacons and measures the one or more UL beacons. For example, a first ESL controller of the ESL controllers 606 measures a first RSSI from a first beacon from a first device of the devices 608 and a second ESL controller thereof measures a second RSSI of the first beacon from the first device. In some implementations, the first device and/or other devices of the devices 608 may send additional beacons, such as in subsequent UL windows, and the ESL controllers may measure these subsequent beacon(s). The ESL controllers, including ESL controllers 606, may generate measurement information based on performing one or more measurement operations on the received UL beacon(s) from the device(s) 608, and other devices not shown. Additionally, or alternatively, the measurement information may include RSRP, AoA, TOA, or any combination thereof. As described above, the beacons include an address of the device which sent the beacon. This enables the ESL system to identify outside devices, such as devices 608.

At 670, one or more of the devices 608 optionally performs a power save operation. For example, the first device of the devices 608 optionally transitions to a low-power state, turns off or reduces power to one or more RF components, etc. during DL slots that correspond to the UL slots indicated in the UL schedule change information. Alternatively, the devices 608 may determine when to perform the power save operation, such as for what time window or which DL slots, based on the DL schedule change information. The devices 608 may receive the DL schedule change information from the ESL server 602 directly or via another ESL component (e.g., relayed by one or more ESL components). To illustrate, the DL schedule change information may be relayed by the ESL AP 604 in unicast or broadcast transmission or included in beacon transmissions (e.g., beacon starts and/or beacon transmissions).

Although not illustrated in FIG. 6 for space, one or more of the ESL controllers 606 may also optionally perform a power save operation. For example, the ESL controllers 606, or a subset thereof, optionally transition to a low-power state, turn off or reduce power to one or more RF components, etc. during DL slots that correspond to the UL slots indicated in the UL schedule change information. Alternatively, the ESL controllers 606 may determine when to perform the power save operation, such as for what time window or which DL slots, based on the DL schedule change information. The ESL controllers 606 may receive the DL schedule change information from the ESL server 602 directly or via another ESL component (e.g., relayed by one or more ESL components). To illustrate, the DL schedule change information may be relayed by the ESL AP 604 in unicast or broadcast transmission or included in beacon transmissions (e.g., beacon starts and/or beacon transmissions).

At 675, the ESL controllers transmit measurement information for the devices 608 to the ESL system. For example, two or more ESL controllers, including ESL controllers 606, each transmit measurement information to the ESL server 702 via the ESL AP 704. The measurement information, such as measurement information 542 of FIG. 5, from multiple ESL controllers and/or from multiple beacons can be used together to determine (e.g., triangulate) a position of a particular device of the devices 608, such as a position indicated by position information 545 of FIG. 5.

In some implementations, one of the devices 608 transmits a request, such as request information, indicating a position based request to the ESL system. For example, a first device of the devices 608 may transmit a request to find a specific object or product (e.g., ESL associated with the object or product). The request may be sent with or independent of the positioning information. The ESL system may then use the positioning information to provide services to the device (e.g., a user thereof), such as guidance, and/or may use the positioning information to improve ESL operations.

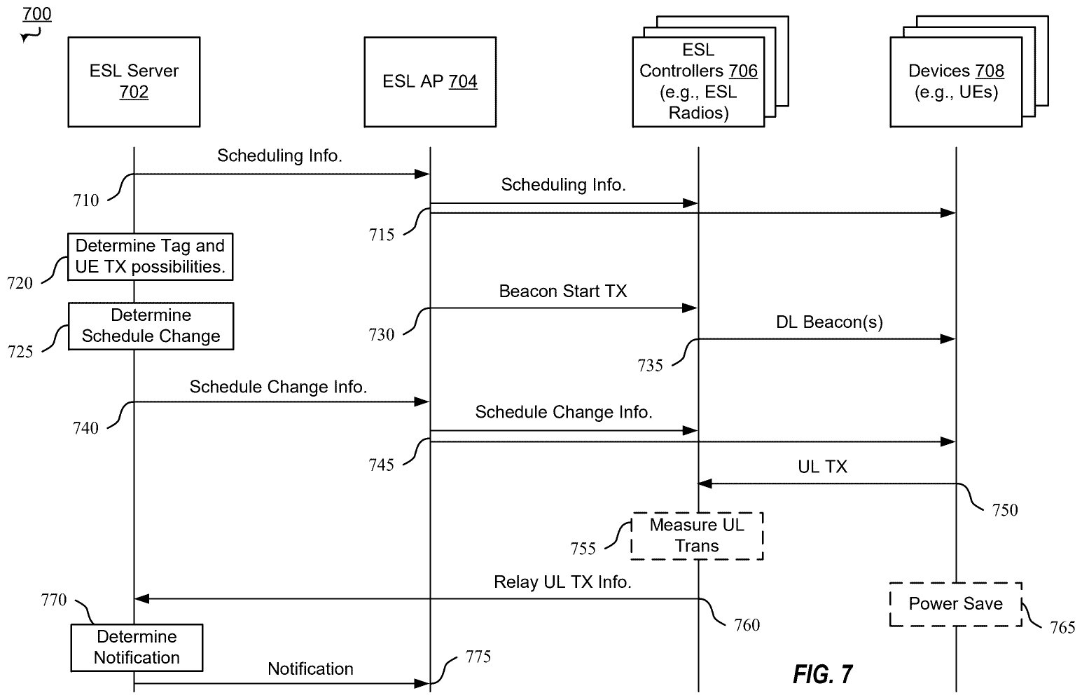

At 680, the ESL server 602 determines a position for the devices 608 based on the received beacon measurement information from the ESL controllers. For example, the ESL server 602 determines a position, positioning information, of the first device of the devices 608 based on first measurement information (e.g., a first RSSI) from the ESL controllers 606 and the second measurement information (e.g., a second RSSI) from another ESL controller, where the first and second measurement information correspond to a measurement of the first beacon from the first device of the devices 608. In some implementations, the ESL server 602 determines the position of the first device based on the additional (e.g., third) measurement information from one or more other beacons and based on historical measurement information, historical position information, or inertial information. For example, the ESL server 602 may determine the position for the first device by adjusting an initial measured position based on prior positions, and/or prior beacon measurements. After determining a position of one or more of the devices, and receiving a request for a position based notification, the ESL server 602 may engage in position based notification operations, described further with reference to FIG. 7.

Referring to FIG. 7, FIG. 7 is a timing diagram 700 illustrating an ESL system that supports enhanced ESL position determination coexistence operations according to one or more aspects. The example of FIG. 7 corresponds to an example of position determination for a device interacting with the ESL system where the measurements are determined based on signals or beacons from ESL radios/controllers by the device, and then relayed to the ESL system for position determination.

In the example of FIG. 7, the ESL system includes an ESL server 702, an ESL AP 704, ESL controller(s) 706 (e.g., ESL radios), and device(s) 708 (e.g., UEs). The ESL controller(s) 706 may each include or correspond to an ESL with a wireless radio or a wireless device/radio associated with a plurality of ESLs. Although one ESL AP is illustrated, the ESL system may include multiple ESL APs, each serving multiple ESL controllers and devices.

Prior to 710, the ESL system may be configured with initial position information and/or configurations for network operation and positioning determining operations. For example, an operator may setup or preconfigure the system with initial positions for one or more devices and/or assets of the ESL systems. To illustrate, one or more of ESL APs, ESL controllers, ESLs, or assets (which may be tagged with an IoT tag) may be configured with an initial position. As another example, the ESL system may enter, such as upon initial setup, reconfiguration, or periodically (e.g., nightly weekly, monthly, quarterly, etc.), a measurement mode to determine initial or updated positions.

For example, the ESL server 702 may transmit configuration information (e.g., the configuration transmission 550 or the ESL settings information 546 of FIG. 5) to the ESL AP 704 and the ESL controllers 706. To illustrate, the ESL server 702 may transmit the configuration information directly to each device, such as by broadcast transmission or direct transmission, or the ESL server 702 may transmit the configuration information to ESL AP 704, which then transmits or relays then configuration information to one or more ESL devices, such as the ESL controllers 706. In an illustrative, non-limiting example, the ESL server 702 may transmit the configuration to ESL AP 704 via a wired connection, and the ESL AP 704 may unicast or broadcast the configuration information to the ESL devices and non-ESL devices.

As described above, the configuration information may include information configured to enable scheduling and timing coordination. For example, the configuration information may include UL and DL slot timing information for the difference devices or types/groups of devices.

Additionally, or alternatively, initial position information may be transmitted in the configuration information. For example, the operator may input a position into the ESL controllers 706, and the ESL controllers 706 may relay that position to the ESL server 702 via the ESL AP 704. As another example, the operator may configure the ESL server 702 with the position of the ESL controllers 706, which is then relayed to the ESL controllers 706 via the ESL AP 704. As yet another example, each of the ESL controllers 706 determines its position based on a beacon of the ESL AP 704, and transmits its determined position to the ESL server 702.

At 710, the ESL server 702 may transmit scheduling information to the ESL AP 704 for relay to other ESL devices and to non-ESL devices. For example, the ESL server 702 may unicast or broadcast a transmission to one or more ESL APs, including the ESL AP 704, which indicates or includes ESL scheduling information. The ESL AP 704 may utilize the ESL scheduling information to determine UL slots for receiving UL transmissions (e.g., beacons or ESL requests), DL slots for transmitting DL transmission (e.g., beacons for measurement or beacon start transmissions/timing transmissions), or both.

At 715, the ESL AP 704 may transmit scheduling information to one or more ESL controllers/devices, including the ESL controllers 706, to one or more devices, including devices 708, or a combination thereof. For example, the ESL AP 704 may relay the scheduling information or transmit ESL controller scheduling information based on the received scheduling information to the ESL controllers. Additionally, or alternatively, example, the ESL AP 704 may relay the scheduling information or transmit device scheduling information based on the received scheduling information to the devices. The scheduling information provided to the ESL controllers and the non-ESL devices may be transmitted in the same transmission or in different transmissions, such as BLE and Wi-Fi transmissions. In the alternative to the above where the ESL AP 704 provides the scheduling information to the non-ESL devices directly, in other implementation the ESL AP provide the scheduling information to the non-ESL devices via the ESL controllers 706.

The ESL AP 704 may transmit the scheduling information by unicast or broadcast a transmission to one or more to one or more ESL controllers/devices. The one or more ESL controllers/devices, including the ESL controllers 706 and devices 708, may utilize the ESL scheduling information to determine UL slots for UL transmissions (e.g., beacons or ESL requests), DL slots for DL transmission (e.g., beacons for measurement or beacon start transmissions/timing transmissions), or both.

At 715, the ESL server 702 may determine uplink transmit possibilities. For example, ESL server 702 may determine uplink transmit possibilities for one or more eTags, one or more devices, or both, for one or more UL slots. To illustrate, the ESL server 702 may estimate or infer the possibility of a particular eTag transmitting during a particular uplink slot or slots (e.g., over an uplink window). When determining the possibility of a particular eTag transmitting during a particular uplink window, the ESL server may utilize an anticipated charging time for the eTag, Q-value of the eTag, and/or a history of transmission for the eTag. In some implementations, the ESL server 702 may determine the possibility that an eTag of a plurality eTags will transmit during a particular uplink window. In such implementations, the ESL server 702 may further utilize the number of eTags in a particular region. The particular region may correspond to or be associated with one or more external devices (e.g., non-ESL infrastructure devices), such as the devices 708.

Regarding the above parameters, the anticipated charging time may correspond to or be based on a signal strength of an energizing signal received at the eTag. The signal strength of the energizing signal received at the eTag correspond to charging time well and can be mapped to a charging time. The known or expected energizing signal strength/coverage (e.g., expected RSSI) may be known beforehand in a certain area. Alternatively, a previous beacon from an eTag may contain the RSSI (of the energizing signal) that was measured by the eTag. The Q-value (or simply ‘Q’) correspond to a parameter that an eTag uses to determine its backoff time for beacon transmissions, as further described with reference to FIG. 10. The Q-value of the eTag is known by the ESL network (e.g., set by the ESL server 702) can be used to determine an average or expected backoff time for a subsequent beacon transmission. The number of eTags can be used to determine a likelihood that a tag will transmit and a higher number of tags in a region would lead to a higher probability of an UL transmission and the UL slot or window being occupied.

In some aspects, the ESL server 702 may use AI/ML techniques to determine the likelihood of a transmission by an eTag or a plurality of eTags. For example, the ESL server 702 may utilize a received model or may train a model based on historic eTag transmissions to determine a likelihood of a future transmission.

Similarly, the ESL server 702 may also determine a likelihood of a transmission by user device. For example, the ESL server 702 may determine a likelihood of a transmission by a UE based on a history of UL transmissions (e.g., UL beacons, ESL notification requests, etc.), a number of UEs, a time since last UL transmission, etc. After the likelihood of a future transmission is determined, such as a possibility of future transmission and a confidence value in the possibility, the output value or values may be evaluated to determine if a schedule change is to be made.

At 725, the ESL server 702 may determine a schedule change based on the determined uplink transmit possibilities. For example, the ESL server 702 may determine an UL schedule change, a DL schedule change, or both based on the determined uplink transmit possibilities. To illustrate, the ESL server 702 may utilize one or more conditions, such as one or more thresholds, to evaluate the determined likelihood of uplink transmissions. For example, the ESL server 702 may include a percentage UL transmission threshold, a number of UL transmissions threshold, a confidence value threshold, etc., as illustrative, non-limiting examples. Alternatively, the ESL server 702 may use an AI/ML model to determine whether to implement a schedule change, and optionally, to determine the particular schedule change (e.g., which slot or slots to reschedule or repurpose).

In some aspects, the ESL server 702 may determine whether to make an UL schedule change based on the determined uplink transmit possibilities, and then may determine to make a DL schedule change based on the determination to make the UL schedule change or based on a determination that the repurposed or rescheduled UL slots were actually used. In other aspects, the ESL server 702 may determine whether to make UL and DL schedule changes based on the determined uplink transmit possibilities. For example, DL slots corresponding to uplink slots identified as available (e.g., low likelihood of eTag transmission or low number of eTag transmissions), may also be rescheduled or repurposed.

At 730, the ESL AP 704 may initiate beacon transmissions by ESL devices. For example, the ESL AP 704 may transmit a beacon start transmission, such as the broadcast transmission at 302 of FIG. 3. To illustrate, the ESL AP 704 may broadcast a transmission which is configured to cause ESL controllers, including ESL controllers 706, to transmit DL beacon transmissions, cause devices (e.g., devices 708) to measure the DL beacon transmissions, cause devices (e.g., devices 708) to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet.

Although the UL schedule change information and DL schedule change information are illustrated in different transmissions in the example of FIG. 7, such may be included in the same transmission in other examples. For example, in some implementations the beacon start transmissions sent by the ESL APs, such as ESL AP 704, may include or indicate the UL schedule change information, the DL schedule change information, or both.

At 735, the ESL controllers transmit one or more DL beacons. For example, one or more ESL controllers, including the ESL controllers 706, transmit a DL beacon during a first DL slot or window based on the scheduling information. The first DL slot or window may include or correspond to an originally scheduled DL slot or window. For example, the first DL slot or window may have originally been scheduled, assigned, or otherwise reserved for DL transmissions by the ESL controllers. The ESL controllers may determine the timing of the DL beacon based on both the scheduling information and the beacon start transmission (e.g., the transmission or reception time thereof).

At 735, the ESL controllers transmit beacons responsive to the beacon start transmission (e.g., beacon frame or synchronization transmission). For example, one or more of the ESL controllers 706 each transmit a beacon (beacon transmission) responsive to the beacon start transmission from the ESL AP 704. To illustrate, a first ESL controller of the ESL controllers 706 broadcast a first beacon after a first delay from the beacon start transmission, and a second ESL controller broadcasts a second beacon after a second delay from the beacon start transmission, etc., in a TDMA fashion, similar to the operations of FIG. 3. The beacon transmissions may include or correspond to Bluetooth transmissions and may correspond to responses to synchronization packets.

At 740, the ESL server 702 may transmit schedule change information for enhanced UL and DL coexistence operations. The ESL server 702 may provide schedule change information to the ESL and non-ESL devices similar to transmission schemes described above for the ESL server 702 providing the scheduling information to the ESL and non-ESL devices. For example, the ESL server 702 may unicast or broadcast a transmission to one or more ESL APs, including the ESL AP 704, which indicates or includes the schedule change information, and the ESL AP 704 then relays the schedule change information to the controllers 706 and devices 708, such as by Wi-Fi or Bluetooth transmission. Alternatively, the ESL APs transmit UL device controller schedule change information to specific devices or groups of devices based on the received UL schedule change information. To illustrate, only certain areas of the ESL system may be affected by the change and only the applicable ESL APs and controllers may receive and transmit the UL schedule change information for the affected devices. As another example, the ESL server 702 may transmit the schedule change information, or a portion thereof, to the devices 708 via another wireless network, such as a cellular network, or via the Internet, similar to as described with reference to FIG. 6.

At 745, the ESL AP 704 may transmit the received schedule change information to the ESL and non-ESL devices for enhanced UL and DL coexistence operations. For example, the ESL AP 704 relays at least the DL schedule change information to the ESL controllers, including ESL controllers 706 and at least the UL schedule change information to the devices, including devices 708, such as by Wi-Fi or Bluetooth transmission. Alternatively, the ESL APs may transmit device or group specific schedule change information to specific ESL controllers or groups of controllers based on the received schedule change information. To illustrate, only certain areas of the ESL system may be affected by the change and only the applicable ESL APs and controllers may receive and transmit the schedule change information from the ESL server and ESL APs respectively. Similarly, the ESL APs may transmit device or group specific schedule change information to specific devices of devices 608 based on the received schedule change information.

Additionally, the ESL server 702 and/or ESL AP 704 may transmit DL schedule change information to the one or more of the devices 708 for enhanced power save operations in some implementations. For example, the ESL AP 704 server 702 may transmit the DL schedule change information with the UL schedule change information or via one of the distribution methods described with reference to the UL schedule change information above. As another example, one or more of the devices 708 may receive the DL schedule change information via beacon type transmissions from the ESL APs or ESL controllers, similar to how ESL controllers receive the DL schedule change information. Similarly, the ESL server 702 and/or ESL AP 704 may transmit UL schedule change information to one or more of the ESL controllers 706 for measuring uplink beacons in some implementations. When the UL schedule change information indicates an uplink grant for an ESL notification request, the UL transmission (i.e., the ESL notification request) may not be measured to the ESL controllers 706 and/or the ESL controllers 706 may engage in a power save operation to conserve battery as they may not need to measure any uplink beacons.

At 750, at least one of the devices 708 transmits an uplink transmission. For example, the first device of the devices 708 transmits an ESL request (e.g., notification request) during a first UL slot or window based on the UL schedule change information. As another example, the first device transmits an UL beacon during a first UL slot or window based on the UL schedule change information, as described with reference to 660 of FIG. 6. The first UL slot or window may include or correspond to a rescheduled or a repurposed UL slot or window. For example, the first UL slot or window may have originally been scheduled, assigned, or otherwise reserved for UL transmissions by other ESL devices, such as eTags, (e.g., eTag UL beacons) or other external devices. The devices 708 may determine the timing of the UL beacon based on both the scheduling information and the UL schedule change information. Additionally, or alternatively, the devices 708 may further determine the timing of the UL beacon based on the DL schedule change information.

At 755, the ESL controllers of the ESL system receive the UL transmission and measure the UL transmission. For example, a first ESL controller of the ESL controllers 706 measures a first RSSI from a first UL transmission from a particular device of the devices 708 and a second ESL controller thereof measures a second RSSI of the first UL transmission from the particular device of the devices 708. In some implementations, the particular device or other devices of the devices 708 may send additional UL transmissions, such as in subsequent UL windows, and the ESL controllers may measure these subsequent UL transmission(s). The ESL controllers, including ESL controllers 706, may generate measurement information based on performing one or more measurement operations on the received UL transmission(s) from the devices 708, and other devices not shown. Additionally, or alternatively, the measurement information may include RSRP, AoA, TOA, or any combination thereof. As described above, the UL transmissions, such as beacons or requests, include an address of the device which sent the UL transmission. This enables the ESL system to identify outside devices, such as devices 708.

At 760, one or more of the ESL controllers of the ESL system transmit UL transmission information to the ESL server. For example, multiple ESL controllers, including the ESL controllers 706, may transmit measurement information for one or more of the devices 708 and based on measuring the UL transmission. Additionally, or alternatively, an ESL controller may transmit or relay a request from one or more of the devices 708 to the ESL server 702, such as to relay request information to the ESL server 702 or to generate and transmit device request information to the ESL server 702 based on the UL transmission (e.g., request information thereof).

In the aspects where the ESL controllers 706 transmit measurement information for the devices 708 to the ESL system at 760, two or more ESL controllers of the ESL controllers 706 each transmits measurement information to the ESL server 702 via the ESL AP 704. The measurement information from multiple ESL controllers and/or from multiple beacons can be used together to determine (e.g., triangulate) a position of one or more of the devices 708. In some such aspects, the measurement information may be generated based on measuring the uplink transmission(s) from one or more of the devices 708, such as measuring an UL beacon or an ESL notification request.

At 765, one or more of the devices 708 optionally performs a power save operation. For example, the first device of the devices 708 optionally transitions to a low-power state, turns off or reduces power to one or more RF components, etc. during DL slots that correspond to the UL slots indicated in the UL schedule change information. Alternatively, the devices 708 may determine when to perform the power save operation, such as for what time window or which DL slots, based on the DL schedule change information. The devices 708 may receive the DL schedule change information from the ESL server 702 directly or via another ESL component (e.g., relayed by one or more ESL components). To illustrate, the DL schedule change information may be relayed by the ESL AP 704 in unicast or broadcast transmission or included in beacon transmissions (e.g., beacon starts and/or beacon transmissions).

Although not illustrated in FIG. 7 for space, one or more of the ESL controllers 706 may also optionally perform a power save operation. For example, the ESL controllers 706 optionally transition to a low-power state, turn off or reduce power to one or more RF components, etc. during DL slots that correspond to the UL slots indicated in the UL schedule change information. Alternatively, the ESL controllers 706 may determine when to perform the power save operation, such as for what time window or which DL slots, based on the DL schedule change information. The ESL controllers 706 may receive the DL schedule change information from the ESL server 702 directly or via another ESL component (e.g., relayed by one or more ESL components). To illustrate, the DL schedule change information may be relayed by the ESL AP 704 in unicast or broadcast transmission or included in beacon transmissions (e.g., beacon starts and/or beacon transmissions).

In some implementations, one or more of the devices 708 transmits a request, such as request information, indicating a position based request to the ESL system. For example, the first device of the devices 708 may transmit a request to find a specific object or product (e.g., ESL associated with the object or product). The request may be sent with or independent of the positioning information. The ESL system may then use the positioning information to provide services to the device (e.g., a user thereof), such as guidance, and/or may use the positioning information to improve ESL operations.

In some aspects, the ESL server 702 determines a position for one or more of the devices 708 based on the received beacon measurement information from the ESL controllers at 760. For example, the ESL server 702 determines a position, positioning information, of the first device of the devices 708 based on first measurement information (e.g., a first RSSI) from a first ESL controller and the second measurement information (e.g., a second RSSI) from another ESL controller, where the first and second measurement information correspond to a measurement of the first beacon from the first device of the devices 708. In some implementations, the ESL server 702 determines the position of the first device of the devices 708 based on the additional (e.g., third) measurement information from one or more other beacons and based on historical measurement information, historical position information, or inertial information. For example, the ESL server 702 may determine the position for the first device of the devices 708 by adjusting an initial measured position based on prior positions, and/or prior beacon measurements.

At 770, the ESL system determines a notification based on the positioning information. For example, the ESL server 702 determines a request for directions from a particular device of the devices 708 for a particular object, and the ESL server determines directions from the position of the particular device of the devices 708 indicated by the positioning information to a position of the object or product stored in the ESL system.

At 775, the ESL system transmits the notification based on the positioning information, and optionally the request information. For example, the ESL server 702 transmits a notification indicating the directions from the position of a particular device of the devices 708 to the position of the object or product stored in the ESL system to the ESL AP 704, as illustrated in FIG. 7. In some aspects, the notification, or the notification information thereof, is transmitted or relayed to one or more ESL controllers 706, one or more of the devices 708, or both. To illustrate, directions can be provided to one or more of the devices 708 and visual and/or audio indications can be provided to one or more of the ESL controllers 706 for outputting such indications to guide a particular device (e.g., user thereof) to the object or product, or location. Additionally, or alternatively, the ESL server 702 transmits a notification indicating the directions from the position of a particular device of the devices 708 to the position of the object or product to one or more of the devices 708 outside of the ESL system, such as independent of the ESL AP 704 and via a cellular network connection.

Referring to FIG. 8, FIG. 8 is a timing diagram 800 illustrating an example of an ESL system that supports enhanced DL and UL positioning coexistence operations according to one or more aspects. In the example of FIG. 8, the ESL system includes an ESL device 802, one or more energizers, including energizer 804, one or more eTags, including eTag 806, and or more devices. The ESL device 802 may include or correspond to any ESL device or devices of the ESL system, such as the ESL server, ESL AP, or ESL controller/radio, as in any of FIGS. 1-7. The energizer may include or correspond to a device which transmits wireless signals for power harvesting both eTags, and the eTags may include or correspond to the eTags 593 of FIG. 5. In some aspects, the energizer could be an ESL AP, ESL controller, or UE device. For example, the eTags may harvest energy from ambient ESL RF signals as opposed to dedicated energizer signals. The device 808 may include or correspond to an ESL system UE or device (e.g., employee UE, robot UE, barcode scanner, etc.) or to a non-ESL system UE or device (e.g., a shopper or customer UE).

Prior to operation, and optionally periodically during operation, the ESL system may determine and propagate initial configuration and/or position information to ESL and non-ESL devices and optional receive initial configuration and/or position information from the ESL and non-ESL devices, as described with reference to FIGS. 5-7. At 810, the ESL device 802 transmits scheduling information to energizers of the ESL system, including the energizer 804. For example, the ESL device 802 transmits a configuration transmission or scheduling information transmissions which includes or indicates a timing scheme or transmission schedule for the ESL network, such as one or more ESL devices thereof, and optionally for non-ESL devices. Alternatively, the ESL device 802 may transmit a trigger transmission, such as a beacon start transmission or an energizing start transmission, after the energizers have received timing information, to start or coordinate the transmission of energizing signals. The transmission may come from an ESL AP or an ESL controller of the ESL system. In some such implementations, the ESL device 802 (e.g., the same type of ESL device) transmits scheduling information in a first transmission and then later transmits a trigger transmission to one or more of the energizers, such as the energizer 804. In other such implementations, the ESL device 802 transmits the scheduling information or the trigger transmission and another ESL device (e.g., another type of ESL device) transmits the other of the scheduling information or the trigger transmission.

At 815, one or more of the energizers transmit RF energy towards one or more eTags of the system. For example, the energizer 804 may broadcast a signal in one or more directions with signal characteristics that enable external devices to harvest the RF energy and convert it to power. For example, the energizer 804 may transmit a signal with a particular frequency (e.g., in a 500-3500 MHz range) and/or a particular waveform type (e.g., a Sinusoidal waveform), as one illustrative, non-limiting example.

At 820, the eTags charge based on received energizer signals, including the energizer signal from the energizer 804 at 815. For example, the eTag 806 receives the energizer signal from the energizer 804 and processes the signal to harvest energy from the signal. To illustrate, the eTag 806 may include a rectifier, and optionally an impedance matching circuit, to convert the received analog RF energy into DC power. The eTag may harvest energy from multiple energizer signals to charge in some implementations. In some such implementations, the multiple energizer signals may be transmitted by a single energizer device, e.g., serially over multiple energizer windows, or by multiple energizer device over a single energizer window or multiple energizer windows. The time to charge for a particular eTag is based on the signals received and the particular device. The charging time is highly correlated with the distance from the energizer device or devices, such as the energizer 804, and is inversely related to the signal strength and/or distance. For example, the charging time is lowest when the eTag is nearer/closer to one or more eTags, the charging time grows logarithmically and or exponentially as the eTag is further from the energizer device or devices.

At 825, the eTags transmit UL beacons responsive to being charged. For example, the eTag 806 transmits an UL beacon after charging at 820 and during an UL window determined by the scheduling information and optionally a trigger transmission. To illustrate, each eTag 806 may be determine an UL window based on timing/scheduling information and then may determine to transmit during a particular time during the UL window based on being charged (e.g., power/voltage greater than a power/voltage threshold) and based on a random timing backoff. The random timing backoff may be determined based on the Q-value provided by the ESL network or pre-stored at the eTag and one example for determining the timing is illustrated and described with reference to FIG. 10. The UL beacons by the eTags may be used by the ESL system and devices interacting with the ESL system to determine position measurements and for ESL based notifications as described with reference to FIGS. 5-7.

At 830, the ESL device 802 transmits schedule change information. For example, the ESL device 802 transmits UL schedule change information, DL schedule change information, or both (e.g., combined schedule change information or both UL and DL schedule change information) that was determined based on UL transmission inference information/probability information, as described with reference to FIGS. 5-7. The schedule change information may identify one or more devices, one or more groups or subsets of devices, one or more UL slot changes, one or more DL slot changes, or a combination thereof, and may enable non-ESL devices to utilize UL slots where eTags would normally transmit or attempt to transmit and/or enable ESL and non-ESL devices to refrain from transmitting or measuring downlink symbols to enable power savings or entering power saving modes, as described with reference to FIGS. 5-7.

At 835, one or more of the energizers transmit second RF energy towards one or more eTags of the system. For example, energizer 804 may broadcast a signal in one or more directions with characteristics that enable external devices to harvest the RF energy and convert it to power, similar to as described at 815.

At 840, the eTags charge based on received second energizer signals, including the second energizer signal from the energizer 804 at 835. For example, the eTag 806 receives the second energizer signal from the energizer 804 and processes the signal to harvest energy from the signal as described above with reference to 820.

At 845, one or more devices of the devices 808 transmits an UL transmission based on the schedule change information. For example, a UE may transmit an UL beacon transmission or an ESL notification/request in an UL window (or UL slot thereof) based on the schedule change information. The schedule change information may indicate a specific grant for the UE in particular, or may indicate a general or group based grant or grants for multiple UEs, such as multiple UEs in a particular area of the ESL network coverage area. When the transmission includes an UL beacon, the ESL network (e.g., ESL device 802) may determine a position for the device 808 based on the UL beacon (e.g., based on measurements by one or more ESL controllers). When the transmission includes an ESL notification or request, the ESL network (e.g., ESL device 802) may determine a notification indication for or associated with the device 808, based on a previously determine position for the device 808 or based on a position for the device 808 determined based on measuring the UL notification/request (e.g., based on measurements by one or more ESL controllers).

At 850, at least one device of the one or more devices 808 optionally performs a power save operation based on the schedule change information. For example, the device 808 may enter a power save mode based on the schedule change information during one or more DL slots indicated in the scheduled change information or during one or more DL slots that are associated with UL slots indicated in the scheduled change information. The device 808 may go to sleep or transition to a lower power mode during a DL window (e.g., one or more DL slots) of the ESL timing cycle and may refrain from attempting to measure DL beacons from one or more ESL controller. In some such implementations, the ESL controllers may also refrain from transmitting DL beacon signals during the DL window (e.g., one or more DL slots) of the ESL timing cycle based on the scheduled change information.

At 855, one or more of the energizers transmit third RF energy towards one or more eTags of the system. For example, energizer 804 may broadcast a signal in one or more directions with characteristics that enable external devices to harvest the RF energy and convert it to power, similar to as described at 815 and 835.

Although energizer and eTags, such as energizer 804 and eTag 806, are not illustrated in the diagrams of FIG. 6 or 7, the ESL system may include one or more energizer and one or more eTags as illustrated in FIG. 8 and such energizers and eTags may engage in charging and UL beacon operations to enable determination of positions of the eTags (e.g., products associated therewith) and to enable directions/notifications to be provided to devices (e.g., ESL and non-ESL devices) to help the devices navigate to and locate the eTags (and associated product(s)).

At 860, the ESL device 802 optionally perform a power save operation based on the schedule change information. For example, the ESL device 802 (e.g., an ESL controller/radio) may enter a power save mode based on the schedule change information during one or more DL slots indicated in the scheduled change information or during one or more DL slots that are associated with UL slots indicated in the scheduled change information. The ESL device 802 may go to sleep or transition to a lower power mode during a DL window (e.g., one or more DL slots) of the ESL timing cycle and may refrain from attempting to measure DL beacons from one or more ESL controller.

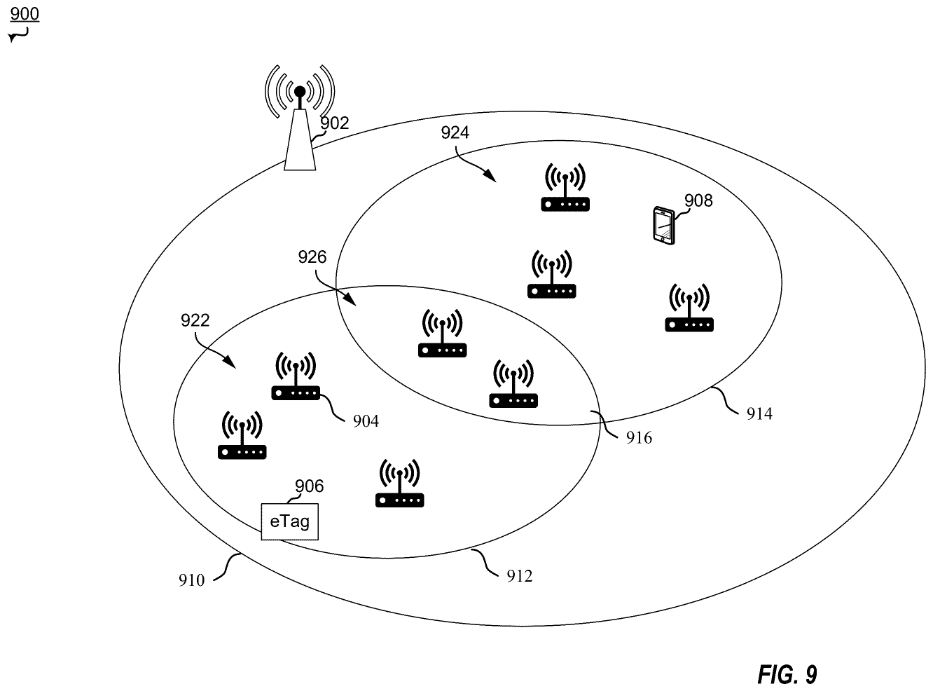

Referring to FIG. 9, diagram 900 illustrates a diagram of an example of ESL system according to one or more aspects of the disclosure. As depicted by diagram 900, the example of ESL system may include a coverage area 910 served by an ESL AP 902. The coverage area may include multiple ESL controllers/radios which may be divided or partitioned into groups. For example, as illustrated in FIG. 9, the coverage area includes a first area 912 (e.g., eTag coverage area or eTag range) associated with an eTag 906 and a second area 914 (e.g., UE coverage area or UE range) associated with a UE 908. These areas 912 and 914 may each be associated with, within range of, and/or served by multiple ESL controllers/radios of a plurality of ESL controllers/radios, collectively ESL controllers 904, as shown in FIG. 9. As illustrated in the example of FIG. 9, the areas 912 and 914 may overlap with each other, as shown by the overlap area 916. Accordingly, some of the first ESL controllers 922 associated with the eTag 906 may also be associated with the UE, i.e., part of the second ESL controllers 924 associated with the UE. To illustrate, third ESL controllers 926 in the overlap area 916 are part of the first ESL controllers 922 and the second ESL controllers 924. FIG. 9 illustrates a simplified example of an ESL system; the ESL system may include multiple ESL APs and multiple AP coverage areas within an ESL system coverage area. Additionally, these AP coverage areas might overlap with each other.

The devices of FIG. 9 may include or correspond to one or more devices of the previous figures. For example, the ESL AP 902 may include or correspond to the ESL device 501 or 802 of FIGS. 5 and 8 or an ESL AP as in FIGS. 6 and 7. The ESL controller/radio may include or correspond to the ESL device 501 or 802 of FIGS. 5 and 8 or an ESL controller as in FIGS. 6 and 7. The eTag 906 may include or correspond to the eTags 593 of FIG. 5 or the eTags 806 of FIG. 8. The UE 908 may include or correspond to the wireless device 503 of FIG. 5, a device of the devices 608 of FIG. 6, a device of the devices 708 of FIG. 7, or the device 808 of FIG. 8.

In some aspects, two or more ESL controllers (e.g., an ESL radio or multiple ESL radios associated therewith) of the ESL system may be grouped together to create groups for enhanced UL and DL coexistence. For example, as some ESL system may be large, the interference caused by a particular transmission may be local to a particular area and group of devices. The ESL system may partition the devices into groups, based on area, device density, device type, device association, etc., or a combination thereof, using known position information of the ESL devices, the eTags, and/or the non-ESL devices. Using ESL groups may further enhance the improvements of above UL and DL coexistence and scheduling adjustment methods by enabling multiple difference scheduling adjustments simultaneous and/or enabling scheduling adjustments for one area and not another.

To illustrate, based on a currently known position estimate or setup configuration/information, a first subset of ESL controllers/radios may be identified by the ESL system to operate in a receive mode for subsequent position estimates during a particular time period. As an example, the subset may be in the vicinity (e.g., within 2 meters, as an illustrative, non-limiting example) of one or more eTags that are charged and/or likely to transmit. Similarly, the ESL system may identify a second subset of ESL controllers/radios to operate in a transmit mode for subsequent position estimates during the particular time period.

In some such aspects that involve ESL device grouping, there may be a time period or event where an eTag and a mobile device are in the same vicinity, as illustrated in the example of FIG. 9. In such situations, this may cause groups of ESL device to overlap and have to operate in both transmit and receives modes, consuming more power and leading to more interference. For example, some ESL controllers/radios that are part of a first subset of ESL controllers/radios (e.g., first ESL controllers 922) which are associated with the eTag 906, may also a be part of a second subset of ESL controllers/radios (e.g., second ESL controllers 924) that are associated with the mobile device, the UE 908. These overlapping devices (e.g., third ESL controllers 926) may be configured to operate in both transmit and receive, leading to a substantial increase in their power consumption. As such devices may be battery powered, power consumption and power uniformity are important factors that can be managed to reduce the operational costs from batteries and labor to replace batteries.

The ESL system may modify ESL groups, such as by modifying the groups and/or by partitioning the groups or making subgroups/subsets, to manage the power consumption and power uniformity and/or to perform scheduling adjustments on a more granular level to enable multiple scheduling changes to be performed locally across the coverage area. To illustrate, in the above example the ESL system may determine a third group of ESL controllers/radios may be used in place of the first group of ESL controllers/radios that were originally associated with the eTag. The third group of ESL controllers/radios may include or correspond to a subset of the first group that is created by removing the overlapping ESLs in the first group, that is the ESLs that are part of the first group and part of the second group. To illustrate, third ESL controllers 926 within the overlap area 916 that overlap with/are part of two ESL groups may be removed from the first ESL controllers 922 and/or from the second ESL controllers 924 to create a third group. To determine alternative ESL groups and/or to determine when or how to modify the ESL groups, the ESL system may use one or more parameters, such as location, overlap with the second group or groups, battery threshold, estimated remaining battery life, amount of associated groups/devices, etc., or a combination thereof.

Additionally, or alternatively, the third group may be created by replacing the overlapping ESLs in the first group with other ESL radios. To determine the other ESL radios to add, the ESL system may use one or more parameters, similar to the parameters above for removing devices. As examples, the ESL devices for replacement may be located closest to a centroid of the locations of the ESL radios in the first subset, be above a threshold value of remaining battery life or capacity (in mAh), not belong to the second group, not belong to other groups.

In some such aspects, the ESL system may determine not remove or replace an overlapping device. For example, conditions may exist where not every overlapping ESL controller/radio needs to be removed/replaced. For example, if the ESL devices are determined to improve precision or meet a particular precision threshold the devices may remain. This determination to keep overlapping devices in one or more groups may also be based on one or more other parameters. To illustrate, the ESL system may determine to keep an overlapping device in one or both groups based on a determination that keeping the overlapped device will improve geometric dilution of precision (GDOP), that a remaining battery life value is above a threshold value, or both, as illustrative, non-limiting examples.

Although the example above was described for creating an alternative group or subset (the third subset) for the first group, in other examples and additional or alternative group (e.g., a fourth group) may instead be used in place of the second group for the mobile device. The fourth group may include or correspond to a subset of devices of the second group. The grouping process (e.g., grouping and adjusting/regrouping) may be repeated iteratively as battery levels change and eTags and devices move through the ESL coverage area.

In some implementations, the ESL system may have multiple devices that are awaiting an UL slot or that could have their position updated via transmission of an uplink beacon. For example, the ESL system may determine multiple devices are within the system or a region thereof, such as based on prior positioning information, and then the ESL system may determine a priority associated with the devices and generate the schedule change information based on the priority. For example, the ESL system may identify a particular device in the schedule change information by indicating a specific grant or adjustment for the particular UE.

As an example of the priority determination, the devices may be ranked using one or more parameters, such as latency, battery level, device type, time since last transmission, time since last position determination, etc., or a combination thereof. For example, a device with a low (or high) transmission latency (e.g., time since last transmission) may be given higher or lower priority for scheduling depending on the operations of the ESL system, a device associated with a store employee may be assigned a higher or lower priority for scheduling than a customer depending on store operations or parameters, etc. In some such aspects, the devices with a higher priority value or rank, may be scheduled first, such as in a first slot or window, and devices in lower priority values may be scheduled in later slots or windows, and in some cases only after the higher priority devices have actually completed a transmission.

In other such aspects, the multiple devices may be ranked in terms of priority level (e.g., with an absolute ranking or with a grouping, such as high, medium, and low), and the device with the highest priority may be assigned a time slot with the least probability of a transmission and the device with the lowest priority may be assigned a time slot with the highest probability of a transmission.

In some such aspects when priority and/or region based update/device grouping is used, such aspects may be enabled or disabled based on one or more conditions. For example, the proposed scheme may be disabled when the ratio of the number of eTags to the number of mobile devices exceeds a threshold value (e.g., 2, 3, 4, 5, 10, etc.) or the absolute number of eTags within a given region (e.g., an ESL device coverage area, an aisle, side of an aisle, portion of an aisle, etc.) exceed a threshold value (e.g., 5, 10, 20, 25, 50, 100, etc.). When there are a large number of eTags, the chances of collisions are much greater, and the mobile devices can continue to be served by DL beacons instead.

In some aspects, the inferred eTag transmission probability can be generalized in the sense of an eTag ‘TX resource opportunity.’ The eTag TX resource opportunity may include or correspond to a combination of time resources, frequency resources, spatial resources (e.g., direction and/or area), and/or coding parameters (e.g., orthogonal—such as cyclic-shifts—or nonorthogonal like PN sequences). Specific coding parameters may also be assigned to the UEs to increase this ‘orthogonalization’. In other words, the use of frequency or code division multiple access can also affect the probability of a slot being occupied or experience interference, and in such aspects the ESL system may utilize these additional parameters to determine the eTag transmission probability for a particular Tx resource opportunity and/or region, as opposed to just a transmission time or window (i.e., time resources only).

FIG. 10 is a timing diagram 1000 illustrating an example of a timing schedule for ESL communications. As illustrated in the timing diagram 1000, the ESL system includes multiple scheduling schemes and/or time windows for different devices. The timing diagram 1000 includes a beacon timing portion or DL portion time scheme 1002, similar to the timing diagram of FIG. 3.

The timing diagram 1000 also includes an energizer time scheme 1004 shown with respect to the beacon timing portion or DL portion time scheme 1002, where energizing devices transmit energizing signals to eTags. For example, the energizer time scheme 1004 may include transmission of energizing signals sent during a DL portion of the ESL network. The energizing signals may include timing information, such as wake-up and/or synchronization information for eTags. In other implementations, energizers may not be used, and ESL radios or ESL APs may transmit similar “energizing” transmissions in addition to or in the alternative of the energizers. As an illustrative example, the wake-up signal may include multiple portions, such as a preamble portion (WUS-P) and a data portion (WUS-D), as illustrated in the example of FIG. 10.

The timing diagram 1000 further includes an uplink portion time scheme 1006 shown with reference to eTag transmissions. As described above, the slots of the uplink portion will not always be used by the eTags, as eTags may not be present in the system, may still be charging, or may be performing a random backoff within the window. This UL portion may be repurposed by the ESL system to enable devices, such as mobile devices or UEs, to transmit UL beacon transmissions or requests to the ESL system as described in the above description.

The UL portion may include one or more UL windows, and each UL window may include or more slot, and one or more subframes thereof depending on the numerology. As illustrated in the example of FIG. 10, an UL portion includes a single UL window that includes multiple slots. Each slot may include multiple subframes, such as 2, 4, 6, etc. The UL portion may occur anywhere during the ESL cycle, such as prior to a DL portion (e.g., beacon, energizer, or both), after a DL portion, between two DL portions, etc. In the example of FIG. 10, the UL portion comes after the initial transmission from the ESL AP (e.g., ESL beacon start transmission) and before the responses from the ESLs (e.g., ESL beacons) and Energizer transmissions.

The timing diagram 1000, and portions thereof, may represent a base scheduling scheme that is indicated by scheduling/timing information or ESL configuration information. The timing diagram 1000, and portions thereof, may be adjusted by schedule change information, such as UL schedule change information, DL schedule change information, or both. The schedule change information may indicate additional UL slots or grants for UEs, additional DL slot or grants for beacons, removal of UL slots for eTags, and/or removal of DL slots for ESL devices (e.g., ESL controllers).

During operation, an eTag may start with energy harvesting (or always be passively energy harvesting) from ESL transmission RF energy to charge a circuit. Once the energy harvested satisfies a threshold, such as a voltage thresholds (e.g., 0.5 to 1.5 volts) the eTag may begin a transmission process. For example, the eTag may monitor for a wake-up signal (e.g., WUS-P) or a peak associated therewith to determine when to send a beacon transmission. In some aspects, the eTag may determine whether the wake-up signal satisfies a received power threshold, such as RSSI, in order to filter out wake-up signals that are farther away and/or for other eTags or to determine to perform a backoff procedure. When performing the backoff procedure, the eTag may determine a Q-value and perform a random backoff by selecting M subframes to sleep for between zero and Q. The Q-value may be known to the eTag prior to wake-up or receiving the energizing signal, such as pre-programmed or configured prior to the energy harvesting and energizing signal, or may be indicated by the energizing signal, such as by the WUS-P or WUS-D thereof.

After performing the random backoff, i.e., waiting M subframes, the eTag may transmit perform a clock synchronization operation and transmit in one of the UL slots. After transmission, the eTag will charge again and repeat the process. In some aspects, the eTag will delay a particular number of subframes, such as N, and stay silenced for the subframes before attempting to transmit again (e.g., determine whether the voltage condition is satisfied).

The eTag charging time is well correlated with distance from received signals, such as received ESL beacon transmissions. The eTag charging time may increase exponentially with increasing distance from a beacon (and the corresponding decreasing signal strength associated with the increased distance).

In the enhanced downlink and uplink coexistence operations described herein, the ESL system, such as an ESL server or ESL AP thereof, may determine the eTag transmission probability for one or more eTags of the system and determine to adjust the scheduling information or timing of the portions 1002-1006 of the timing diagram 1000. For example, the ESL system may determine that an e-Tag or group of e-Tags in a particular region are not likely to transmit during one or more slots (or subframes) of an UL window, and the ESL system may adjust the timing to utilize UL position determination operations instead of DL position determination operations for a particular ESL cycle. To illustrate, the ESL system may distribute UL schedule change information to one or more non-ESL devices (and optionally ESL devices) to indicate one or more additional UL grants during the ESL cycle, such as the uplink portion time scheme 1006 corresponding to the eTags.

The ESL system may also distribute DL schedule change information to the ESL devices, or a subset thereof, to indicate cancelling of one or more DL grants during the ESL cycle, such as the DL portion time scheme 1002 corresponding to the ESL devices (ESL APs and/or controllers). In such aspects, the ESL server may not send or cause the ESL AP to refrain from sending a beacon start transmission, or may cause the ESL controllers, or a subset thereof, to not send a beacon transmission. Generation and distribution of the DL schedule change information may be used to avoid using both UL and DL-based position determination operation and may be able to conserve power for the ESL devices, such as the battery powered ESL controllers. Accordingly, the ESL system can leverage using UL position determination operations dynamically when UL slots are likely to be available due to a low probability of eTag transmissions, and the ESL system can save power from refraining from using duplicative DL position determination operations.

Position estimation as described herein may utilize RSSI, AoA, and/or TOA. In some aspects, the position estimation utilizes RSSI to enable lower complexity devices to engage in measurement operations for position estimation. Other signal quality or strength metrics may be used, such as RSRP or RSRQ.

In some aspects, a centroid algorithm may be used to determine position, such as known in the ESL position determination art. Trilateration using RSSI has been observed to be highly unreliable since the RSSI is very susceptible to attenuation, which in turn leads to poor range estimation accuracy. Instead, a Weighted Centroid Algorithm (WCA) has been observed to be much more robust to attenuation and no-line-of-sight (NLOS) effects. A device, e.g., UE or eTag, position may be estimated by a weighted average of ESL radio positions where the weights are functions of RSSI values.

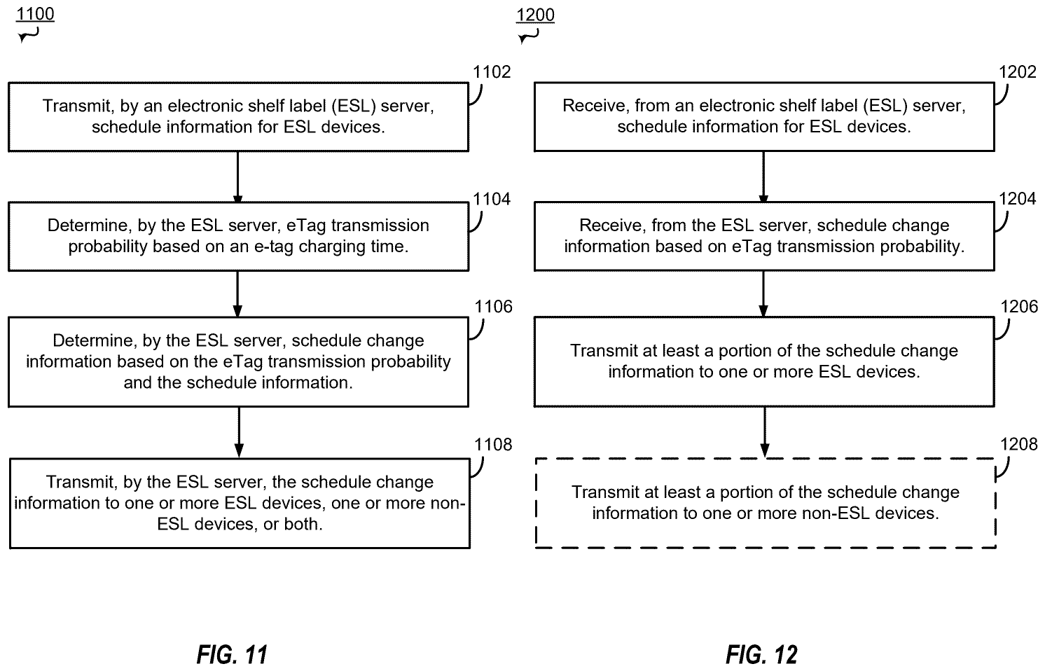

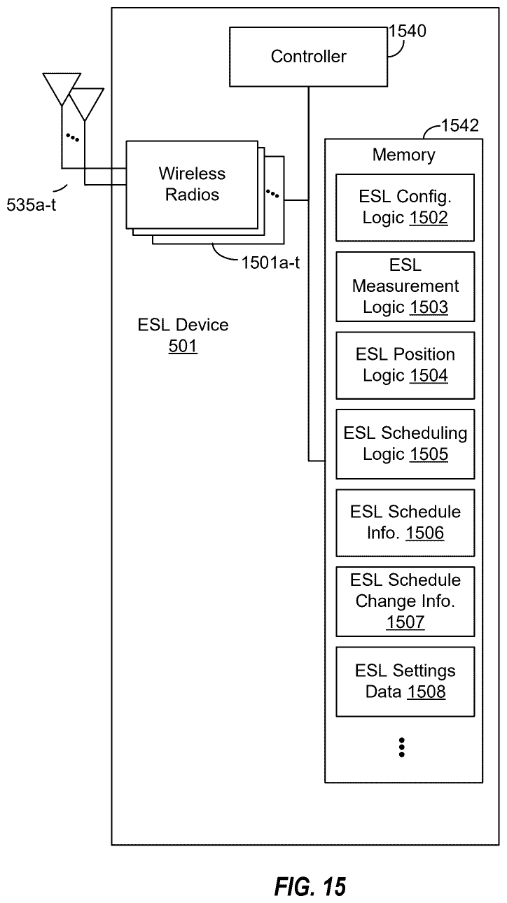

FIG. 11 is a flow diagram 1100 illustrating example blocks executed by wireless communication device (e.g., an ESL device or a UE) configured according to an aspect of the present disclosure. The example blocks will also be described with respect to ESL device 501 as illustrated in FIG. 15. FIG. 15 is a block diagram illustrating ESL device 501 configured according to one aspect of the present disclosure. ESL device 501 includes the structure, hardware, and components as illustrated for ESL device 501 of any of FIG. 5. For example, ESL device 501 includes controller/processor 1540, which operates to execute logic or computer instructions stored in memory 1542, as well as controlling the components of ESL device 501 that provide the features and functionality of ESL device 501. ESL device 501, under control of controller/processor 240, transmits and receives signals via wireless radios 1501a-t and antennas 535a-t. As illustrated in the example of FIG. 15, memory 1542 stores one or more of ESL configuration logic 1502, ESL measurement logic 1503, ESL position logic 1504, ESL scheduling logic 1505, ESL schedule information 1506, ESL schedule change information 1507, or ESL settings data 1508. The data (1502-1508) stored in the memory 242 may include or correspond to data and/or logic to enable the operations of FIGS. 5-10.

At block 1102, a wireless communication device, such as an ESL device (e.g., an ESL server), transmits schedule information for ESL devices. The schedule information may include or correspond to configuration information of the configuration transmission 550 or the scheduling information transmission 552, such as the scheduling information 506 and/or the ESL settings information 544 thereof, of FIG. 5, the scheduling information transmitted at 610-620 of FIG. 6, the scheduling information transmitted at 710-715 of FIG. 7, or the scheduling information transmitted at 810 of FIG. 8. The ESL devices may include or correspond to any of the devices associated with and/or controlled by an ESL as described in any of FIGS. 5-9, such as an ESL server, and ESL AP, an ESL controller/radio, or an e-Tag. For example, the ESL device 501 transmits the scheduling information transmission 552, including the scheduling information 506, for UL and DL position estimation operations for ESL devices (such as ESL devices 591), to the ESL devices 591 and for non-ESL devices (such as to eTags 593 and/or wireless device 503), or both. Other examples are also described in FIGS. 6-8.

At block 1104, the wireless communication device determines eTag transmission probability based on an eTag charging time. The eTag transmission probability may include or correspond to the transmission probability information 543 of FIG. 5 or the transmission probability information determined at 625 of FIG. 6, 720 of FIG. 7, or 830 of FIG. 8. For example, the ESL device 501 determines eTag transmission probability for one or more e-Tags based on an eTag charging time for one or more e-Tags, such as eTags 593. As another example, an ESL server, such as ESL server 602, 702, or ESL device 802, determines eTag transmission probability based on an eTag charging time at 625, 720, or 830. The eTag charging time may be determined based historic charging times, the position of the ESL devices and eTags, the scheduling information 506 (e.g., energizer device transmission schedule), previous schedule change information, or a combination thereof, as illustrative, non-limiting examples. The eTag transmission probability may be further based on number of devices/eTags, a backoff value (e.g., Q-value), or both, in some aspects.

At block 1106, the wireless communication device determines schedule change information based on the eTag transmission probability and the schedule information. The schedule change information may include or correspond to the schedule change information 508 of FIG. 5, or one or more of the UL schedule change information, the. DL schedule change information, or the combined schedule change information of FIGS. 6-8. For example, the ESL device 501 generates the schedule change information 508 based on the transmission probability information 543 and the scheduling information 506. As another example, an ESL server, such as ESL server 602, 702, or ESL device 802, determines schedule change information based on an eTag transmission probability and the schedule information at 630, 725, or 830. In some aspects, the ESL device 501 generates the schedule change information 508 further based on time, proximity, priority, or a combination thereof. For example, the ESL device 501 may evaluate one or more conditions or thresholds associated with the above parameters for determining if a schedule change should be made. The schedule changes may include or corresponds to a particular time resource, a particular frequency resource, a particular spatial resource, or a particular transmit opportunity, such as any combination of time, frequency, space, and/or coding parameters that may allow simultaneous communication.

At block 1108, the wireless communication device transmits the schedule change information to one or more ESL devices, one or more non-ESL devices, or both. For example, the ESL device 501 transmits the schedule change information 508 for UL and DL position determination to ESL and non-ESL devices in a scheduling change transmission 556. The scheduling change transmission 556 may be sent to ESL devices (such as ESL device 591), non-ESL devices (such as wireless device 503), or both. As another example, an ESL server, such as ESL server 602, 702, or ESL device 802, determines schedule change information based on an eTag transmission probability and the schedule information at 630, 725, or 830.

After block 1108, the wireless communication device may engage in position determination operations based on the schedule change information. For example, the wireless communication device may obtain position information and use the position information for ESL notification operations. For example, the ESL device 501 may transmit notifications to non-ESL devices responsive to notification requests and indicating a requested location or asset, and may optionally cause ESLs to display indications to non-ESL devices that are associated with the notifications, as described with reference to FIGS. 5-10.

The wireless communication device (e.g., UE or ESL device) may execute additional blocks (or the wireless communication device may be configured further to perform additional operations) in other implementations. For example, the wireless communication device, such as one or more processors and one or more memories (e.g., a processing system) thereof, may perform one or more operations described above, such as described with reference to FIGS. 5-10 or as described below. As another example, the wireless communication device may perform one or more aspects as presented below.

Accordingly, wireless communication devices may perform enhanced UL and DL position coexistence operations to dynamically and flexibility use both UL and DL resource to determine position information for position or location based operations, such as position based notification operations. In some aspects, the wireless communication devices may utilize UL-based position estimation operations instead of DL-based position estimation operations to reduce batter consumption. Accordingly, the network performance and user experience may be increased due to enhanced UL and DL position coexistence operations and position based notifications.

FIG. 12 is a flow diagram 1200 illustrating example blocks executed by wireless communication device (e.g., a UE or an ESL device) configured according to an aspect of the present disclosure. The example blocks of FIG. 12 will also be described with respect to ESL device 501 as illustrated in FIG. 15. The example blocks of FIG. 12 may be practiced by any of the ESL devices described herein.

At block 1202, a wireless communication device, such as an ESL device (e.g., ESL AP), receives, from an electronic shelf label (ESL) server, schedule information for ESL devices. The schedule information may include or correspond to configuration information of the configuration transmission 550 or the scheduling information transmission 552, such as the scheduling information 506 and/or the ESL settings information 544 thereof, of FIG. 5, the scheduling information transmitted at 610-620 of FIG. 6, the scheduling information transmitted at 710-715 of FIG. 7, or the scheduling information transmitted at 810 of FIG. 8. The ESL server may include or correspond to ESL device 501 of FIG. 5, ESL server 602 of FIG. 6, ESL server 702 of FIG. 7, or ESL device 802 of FIG. 8. For example, the ESL device 501 transmits the scheduling information transmission 552, including the scheduling information 506, for UL and DL position estimation operations for ESL devices (such as ESL devices 591), to the ESL devices 591 and for non-ESL devices (such as to eTags 593 and/or wireless device 503), or both. As another example, an ESL AP 604 or 704 receives the scheduling information from an ESL server 602 or 702 at 615 of FIG. 6 or 710 of FIG. 7.

At block 1204, the wireless communication device receives, from the ESL server, schedule change information based on eTag transmission probability. The schedule change information may include or correspond to the schedule change information 508 of FIG. 5, or one or more of the UL schedule change information, the. DL schedule change information, or the combined schedule change information of FIGS. 6-8. For example, the ESL device 501 transmits the schedule change information 508 for UL and DL position determination to ESL and non-ESL devices in a scheduling change transmission 556. As another example, an ESL AP, such as ESL AP 604, 704 or ESL device 802, receives schedules change information, generated based on an eTag transmission probability, from the ESL server 602 or 702 at 630, 725, or prior to 830.

At block 1206, the wireless communication device transmits at least a portion of the schedule change information to one or more ESL devices. The at least a portion of the schedule change information may include or correspond UL schedule change information, DL schedule change information, or combined UL and DL schedule change information (e.g., the schedule change information 508). The one or more ESL devices may include or correspond to ESL radios/ESL controllers associated with ESLs, such as any of ESL devices 501, ESL controllers 606, ESL controllers 706, ESL device 802. Additionally, or alternatively, the one or more ESL devices may include energizer devices, e-Tags for assets, worker UEs, or any combination thereof, as described with reference to FIGS. 6-9. For example, the ESL device 501, the ESL AP 604, the ESL AP 704, or the ESL device 802 transmits DL schedule change information or combined schedule change information to any of ESL devices 591, eTags 593, ESL controllers 606, ESL controllers 706, energizers 804, as described with reference to FIGS. 5-10.

At block 1208, the wireless communication device optionally transmits at least a portion of the schedule change information to one or more non-ESL devices. The at least a portion of the schedule change information may include or correspond to a same portion sent to ESL devices or a different portion. The non-ESL devices may include or correspond to shoppers, such as UEs, including any of wireless device 503, devices 608, devices 708, or devices 808, and may optionally include or correspond to eTags, such as eTags 593 or eTags 806. For example, the ESL device 501, the ESL AP 604, the ESL AP 704, or the ESL device 802 transmits UL schedule change information or combined schedule change information to any of wireless device 503, eTags 593 devices 608, devices 708, devices 808, or eTags 806, as described with reference to FIGS. 5-10.

The wireless communication device (e.g., such as a UE or base station) may execute additional blocks (or the wireless communication device may be configured further to perform additional operations) in other implementations. For example, the wireless communication device may perform one or more operations as described with reference to FIGS. 5-11 or as described below. As another example, the wireless communication device may perform one or more aspects as presented below.

Accordingly, wireless communication devices may perform enhanced UL and DL position coexistence operations to dynamically and flexibility use both UL and DL resource to determine position information for position or location based operations, such as position based notification operations. In some aspects, the wireless communication devices may utilize UL-based position estimation operations instead of DL-based position estimation operations to reduce batter consumption. Accordingly, the network performance and user experience may be increased due to enhanced UL and DL position coexistence operations and position based notifications.

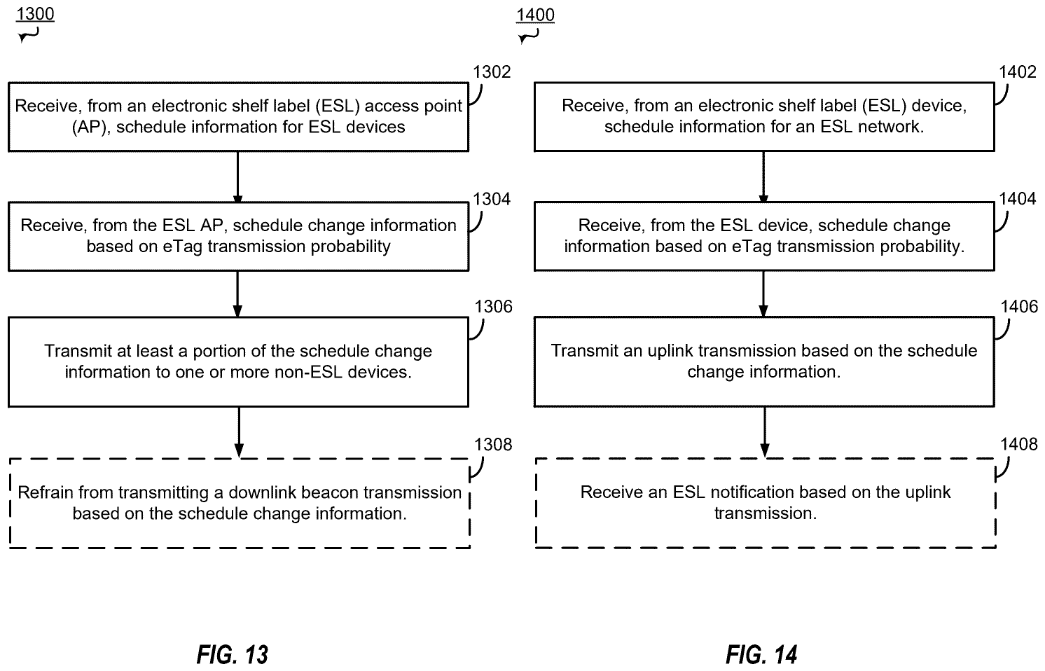

FIG. 13 is a flow diagram 1300 illustrating example blocks executed by a wireless communication device (e.g., a UE or an ESL device) configured according to an aspect of the present disclosure. The example blocks of FIG. 13 will also be described with respect to ESL device 501 as illustrated in FIG. 15. The example blocks of FIG. 13 may be practiced by any of the ESL devices described herein.

At block 1302, a wireless communication device, such as an ESL device (e.g., ESL controller/radio), receives, from an electronic shelf label (ESL) access point (AP), schedule information for ESL devices. The schedule information may include or correspond to configuration information of the configuration transmission 550 or the scheduling information transmission 552, such as the scheduling information 506 and/or the ESL settings information 544 thereof, of FIG. 5, the scheduling information transmitted at 610-620 of FIG. 6, the scheduling information transmitted at 710-715 of FIG. 7, or the scheduling information transmitted at 810 of FIG. 8. The ESL AP may include or correspond to ESL device 501 of FIG. 5, ESL AP 604 of FIG. 6, ESL AP 704 of FIG. 7, or ESL device 802 of FIG. 8. For example, the ESL device 501 transmits the scheduling information transmission 552, including the scheduling information 506, for UL and DL position estimation operations for ESL devices (such as ESL devices 591), to the ESL devices 591 and for non-ESL devices (such as to eTags 593 and/or wireless device 503), or both. As another example, an ESL AP 604 or 704 transmits the scheduling information, received from an ESL server, to one or more ESL radios, as described with reference to FIGS. 5-9.

At block 1304, the wireless communication device receives, from the ESL AP, schedule change information based on eTag transmission probability. The schedule change information may include or correspond to the schedule change information 508 of FIG. 5, or one or more of the UL schedule change information, the. DL schedule change information, or the combined schedule change information of FIGS. 6-8. For example, the ESL device 501 transmits the schedule change information 508 for UL and DL position determination to ESL and non-ESL devices in a scheduling change transmission 556. As another example, an ESL AP, such as ESL AP 604, 704 or ESL device 802, transmits schedules change information, generated based on an eTag transmission probability, to one or more ESL controllers 606, 706 at 655, 745, or 830.

At block 1306, the wireless communication device transmits at least a portion of the schedule change information to one or more non-ESL devices. The at least a portion of the schedule change information may include or correspond UL schedule change information, DL schedule change information, or combined UL and DL schedule change information (e.g., the schedule change information 508). The non-ESL devices may include or correspond to shoppers, such as UEs, including any of wireless device 503, devices 608, devices 708, or devices 808, and may optionally include or correspond to eTags, such as eTags 593 or eTags 806. For example, the ESL device 501, the ESL controllers 606, the ESL controllers 706, or the ESL device 802 transmits UL schedule change information or combined schedule change information to any of wireless device 503, eTags 593 devices 608, devices 708, devices 808, or eTags 806, as described with reference to FIGS. 5-10.

At block 1308, the wireless communication device optionally refrains from transmitting a downlink beacon transmission based on the schedule change information. The downlink beacon may include or correspond to any downlink beacon described with reference to FIGS. 3-11 which are not sent due to the schedule change information indication to perform UL-based position determination operations instead of DL-based position determination, including the unsent DL beacon 559 of FIG. 5 or the DL beacons not sent during the power save operations at 670, 765, 850, or 860.

After block 1308, the wireless communication device may engage in position determination operations based on the schedule change information. For example, the wireless communication device may obtain position information and use the position information for ESL notification operations. For example, the ESL device 501 may transmit notifications to non-ESL devices responsive to notification requests and indicating a requested location or asset, and may optionally cause ESLs to display indications to non-ESL devices that are associated with the notifications, as described with reference to FIGS. 5-10.

The wireless communication device (e.g., UE or ESL device) may execute additional blocks (or the wireless communication device may be configured further to perform additional operations) in other implementations. For example, the wireless communication device may perform one or more operations described above, such as described with reference to FIGS. 5-12 or as described below. As another example, the wireless communication device may perform one or more aspects as presented below.

Accordingly, wireless communication devices may perform enhanced UL and DL position coexistence operations to dynamically and flexibility use both UL and DL resource to determine position information for position or location based operations, such as position based notification operations. In some aspects, the wireless communication devices may utilize UL-based position estimation operations instead of DL-based position estimation operations to reduce batter consumption. Accordingly, the network performance and user experience may be increased due to enhanced UL and DL position coexistence operations and position based notifications.

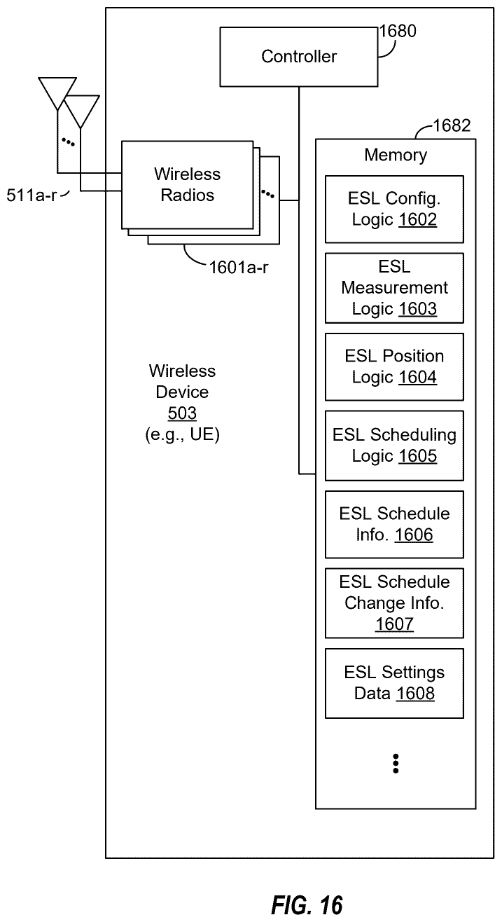

FIG. 14 is a flow diagram 1400 illustrating example blocks executed by a wireless communication device (e.g., a UE or ESL device) configured according to an aspect of the present disclosure. The example blocks will also be described with respect to wireless device 503 as illustrated in FIG. 16. FIG. 16 is a block diagram illustrating wireless device 503 configured according to one aspect of the present disclosure. Wireless device 503 includes the structure, hardware, and components as illustrated for wireless device 503 of FIG. 5. For example, wireless device 503 includes controller/processor 1680, which operates to execute logic or computer instructions stored in memory 1682, as well as controlling the components of wireless device 503 that provide the features and functionality of wireless device 503. Wireless device 503, under control of controller/processor 1480, transmits and receives signals via wireless radios 1601a-r and antennas 511a-r. As illustrated in the example of FIG. 16, memory 1682 stores one or more of ESL configuration logic 1602, ESL measurement logic 1603, ESL position logic 1604, ESL scheduling logic 1605, ESL scheduling information 1606, ESL schedule change information 1607, or ESL settings data 1608. The data (1602-1608) stored in the memory 1682 may include or correspond to data and/or logic to enable the operations of FIGS. 5-10.

At block 1402, a wireless communication device, such as a non-ESL device or UE, receives, from an electronic shelf label (ESL) device, schedule information for an ESL network. The schedule information may include or correspond to configuration information of the configuration transmission 550 or the scheduling information transmission 552, such as the scheduling information 506 and/or the ESL settings information 544 thereof, of FIG. 5, the scheduling information transmitted at 610-620 of FIG. 6, the scheduling information transmitted at 710-715 of FIG. 7, or the scheduling information transmitted at 810 of FIG. 8. For example, the ESL device 501, the ESL server 602, the ESL AP 604, the ESL server 702, the ESL AP 704, or the ESL device 802 transmits scheduling information, such as scheduling information 506, to any of wireless device 503, eTags 593 devices 608, devices 708, devices 808, or eTags 806, as described with reference to FIGS. 5-10.

At block 1404, the wireless communication device receives, from the ESL device, schedule change information based on eTag transmission probability. The schedule change information may include or correspond UL schedule change information, DL schedule change information, or combined UL and DL schedule change information (e.g., the schedule change information 508) and is generated based on an eTag transmission probability by the ESL network. For example, the ESL device 501, the ESL server 602, the ESL AP 604, the ESL server 702, the ESL AP 704, or the ESL device 802 transmits UL schedule change information or combined schedule change information to any of wireless device 503, eTags 593 devices 608, devices 708, devices 808, or eTags 806, as described with reference to FIGS. 5-10.

At block 1406, the wireless communication device transmits an uplink transmission based on the schedule change information. The uplink transmission may include or correspond to the uplink transmission 558 of FIG. 5, the uplink beacons at 660 of FIG. 6, the uplink transmission at 750 (e.g., ESL notification request or uplink beacon) of FIG. 7, or the uplink transmission at 845 of FIG. 8. For example, the wireless device transmits the uplink transmission 558 to the ESL device 501, as described with reference to FIG. 5. As other examples, a device, such as any of devices 608 or 708, may send an uplink transmission to the ESL server, such as ESL server 602 or 702, outside of the ESL system (e.g., via a cellular network) as in FIG. 6 or relayed via one or more ESL devices as in FIG. 7 (e.g., via a local ESL network, such as Wi-Fi or a Bluetooth network).

At block 1408, the wireless communication device optionally receives an ESL notification based on the uplink transmission. The ESL notification may include or correspond to the ESL notification at 775 of FIG. 7. For example, the ESL device 501 may transmit an ESL notification in response to the uplink transmission 558 when the uplink transmission 558 includes an ESL notification request or based on measurements from measuring the uplink transmission 558 when the uplink transmission 558 is an uplink beacon or includes an ESL notification request. As another example, the ESL AP 704 may relay the ESL notification, or notification information thereof, received at 775 to a device of the devices 708.

The wireless communication device (e.g., UE or base station) may execute additional blocks (or the wireless communication device may be configured further to perform additional operations) in other implementations. For example, the wireless communication device may perform one or more operations described above, such as described with reference to FIGS. 5-13 and any of the operations described below. As another example, the wireless communication device may perform one or more aspects as presented below.

Accordingly, wireless communication devices may perform enhanced UL and DL position coexistence operations to dynamically and flexibility use both UL and DL resource to determine position information for position or location based operations, such as position based notification operations. In some aspects, the wireless communication devices may utilize UL-based position estimation operations instead of DL-based position estimation operations to reduce batter consumption. Accordingly, the network performance and user experience may be increased due to enhanced UL and DL position coexistence operations and position based notifications.

In the implementations described herein, an ESL system or network may include an ESL cloud server, one or more ESL gateway servers or edge servers associated with the ESL cloud server, one or more ESL APs associated with each gateway or edge server, one or more ESL controllers associated with each ESL AP, one or more ESLs associated with each ESL controller, and one or more e-Tags associated with each ESL. In some implementations, the ESL system may include a plurality of energizers, which may be associated with multiple e-Tags of the plurality of the e-Tags.

In a first aspect, a device for wireless communication includes: at least one processor; and a memory coupled to the at least one processor, wherein the at least one processor is configured to cause the device to: transmit schedule information for ESL devices; determine eTag transmission probability based on an eTag charging time; determine schedule change information based on the eTag transmission probability and the schedule information; and transmit the schedule change information to one or more ESL devices, one or more non-ESL devices, or both.

In a second aspect, alone or in combination with the first aspect, the schedule change information enables a power save operation for non-ESL devices, refraining from transmission of an ESL downlink beacon by an ESL device, or both.

In a third aspect, alone or in combination with one or more of the above aspects, to transmit the schedule change information includes to: transmit downlink schedule change information to the one or more ESL devices; transmit uplink schedule change information to the one or more non-ESL devices; or transmit combined uplink and downlink schedule change information to the one or more ESL devices, the one or more non-ESL devices or both.

In a fourth aspect, alone or in combination with one or more of the above aspects, the uplink schedule change information is transmitted to the one or more non-ESL device via a cellular wireless network or via a local wireless network.

In a fifth aspect, alone or in combination with one or more of the above aspects, the eTag transmission probability comprises a likelihood of transmission value and a confidence value, and wherein to determine to the schedule change information based includes to: compare the likelihood of transmission value to a transmission probability threshold; and compare the confidence value to a confidence value threshold, wherein the schedule change information is determined based on the likelihood of transmission value satisfying the transmission probability threshold and on the confidence value satisfying the confidence value threshold.

In a sixth aspect, alone or in combination with one or more of the above aspects, to determine the eTag transmission probability includes to: determine a first eTag transmission probability for a first eTag for a first UL transmission time period, wherein the time period is an UL window or an UL slot of the UL window, and wherein the eTag transmission probability is based on the first eTag transmission probability.

In a seventh aspect, alone or in combination with one or more of the above aspects, to determine the eTag transmission probability includes to: determine a second eTag transmission probability for the first eTag for a second UL transmission time period; determine a third eTag transmission probability for a second eTag for the first UL transmission time period; or both, wherein the eTag transmission probability is based on the first eTag transmission probability and one or more of the second eTag transmission probability or the third eTag transmission probability.

In an eighth aspect, alone or in combination with one or more of the above aspects, the first eTag transmission probability is associated with a particular region, and wherein the schedule change information includes one or more schedule changes for the region.

In a ninth aspect, alone or in combination with one or more of the above aspects, to determine the eTag transmission probability includes to: determine a first eTag transmission probability for a first eTag for a first UL transmit resource opportunity, wherein the first UL transmit resource opportunity includes a time resource, a frequency resource, a coding parameter, or a combination thereof, and wherein the eTag transmission probability is based on the first eTag transmission probability.

In a tenth aspect, alone or in combination with one or more of the above aspects, the at least one processor is further configured to cause the device to: determine a priority associated with a particular non-ESL device; determine whether to provide an uplink grant for the particular non-ESL device based on the priority; and generate the schedule change information including the uplink grant for the particular non-ESL device based on the priority and the eTag transmission probability.

In an eleventh aspect, alone or in combination with one or more of the above aspects, the priority is determined based on a transmission latency associated with the particular non-ESL device, a type of the particular non-ESL device, or both.

In a twelfth aspect, alone or in combination with one or more of the above aspects, the at least one processor is further configured to cause the device to: determine a position associated with a particular non-ESL device; determine a position or region associated with the eTag transmission probability; determine whether to provide an uplink grant for the particular non-ESL device based on the position associated with the particular non-ESL device and the position or region associated with the eTag transmission probability; and generate the schedule change information including the uplink grant for the particular non-ESL device based on a difference in the position associated with the particular non-ESL device and the position or region associated with the eTag transmission probability satisfying a distance threshold.

In a thirteenth aspect, alone or in combination with one or more of the above aspects, the at least one processor is further configured to cause the device to: determine a first group of ESL controllers of a plurality of ESL controllers of an ESL system associated with an eTag of the ESL system; determine a second group of ESL controllers of the plurality of ESL controllers of the ESL system associated with a non-ESL device of the ESL system, wherein the eTag transmission probability corresponds to a transmission probability for the eTag and the schedule change information indicates a schedule change for the first group of ESL controllers and for second non-ESL devices associated with the first group of ESL controllers. As described above, groups of ESL controllers (e.g., ESL radios) may be defined or grouped by position, such as being within a certain distance of one another or within a region.

In a fourteenth aspect, alone or in combination with one or more of the above aspects, the at least one processor is further configured to cause the device to: determine a third group of ESL controllers of the plurality of ESL controllers of the ESL system associated with the non-ESL device of the ESL system based on an overlap between the first group of ESL controllers and the second group of ESL controllers.

In a fifteenth aspect, alone or in combination with one or more of the above aspects, the third group of ESL controllers is further determined based on priority associated with the non-ESL device, based on one a location of the ESL controllers of the second group of ESL controllers, a power parameter of the ESL controllers of the second group of ESL controllers, an amount of the ESL controllers of the first or second group of ESL controllers, or a position determination quality metric.

In a sixteenth aspect, alone or in combination with one or more of the above aspects, the at least one processor is further configured to cause the device to: determine to enable or disable scheduling adjustments based on a number of eTags, a number of non-ESL devices, or both. For example, enhanced UL and DL coexistence operations may be enable or disabled based on a ratio between the number eTags and ESL devices or the absolute number of either. To illustrate, a ratio or absolute number may be compared to a threshold value, and the number or ratio may correspond to a number or ratio for a particular region or section of the ESL coverage/service area.

In a seventeenth aspect, alone or in combination with one or more of the above aspects, the eTag charging time corresponds to an anticipated eTag charging time based on a history of eTag charging times or eTag, and wherein to determine the eTag transmission probability includes to: determine the eTag transmission probability based on the anticipated eTag charging time, an eTag backoff parameter, a number of eTags, and a probability threshold.

In an eighteenth aspect, alone or in combination with one or more of the above aspects, the at least one processor is further configured to cause the device to: receive measurement information for an eTag and associated with measurements of uplink beacons from the eTag; and determine a position for the eTag based on the received measurement information.

In a nineteenth aspect, alone or in combination with one or more of the above aspects, the at least one processor is further configured to cause the device to: receive measurement information for a non-ESL device of the one or more non-ESL devices and associated with measurements of uplink beacons from the eTag, uplink beacons from the non-ESL device, or both; and determine a position for the non-ESL device based on the received measurement information.

In a twentieth aspect, alone or in combination with one or more of the above aspects, the at least one processor is further configured to cause the device to: receive position information for a non-ESL device of the one or more non-ESL devices and derived from measurements by the non-ESL device of downlink beacons from the one or more ESL devices.

In another aspect, alone or in combination with one or more of the above aspects, the at least one processor is further configured to cause the device to: receive measurement information for the non-ESL device, the measurement information generated based on UE measurements of downlink beacons from ESL devices; and generate position information for the non-ESL device based on the received measurement information.

In a twenty-first aspect, alone or in combination with one or more of the above aspects, the at least one processor is further configured to cause the device to: obtain position information for a non-ESL device of the one or more non-ESL devices based on an uplink transmission from the non-ESL device (e.g., based on measuring the uplink transmission or the uplink transmission indicating the particular non-ESL device and/or position thereof), the uplink transmission transmitted based on the schedule change information; receive an ESL notification request from the non-ESL device indicating a request associated with a location or asset of the ESL system; and transmit an ESL notification to the non-ESL device indicating the location or asset of the ESL system based on the ESL notification request and the position information for the non-ESL device.

In a twenty-second aspect, alone or in combination with one or more of the above aspects, the at least one processor is further configured to cause the device to: transmit an ESL notification to one or more of the ESL devices and configured to cause the one or more ESL devices to output an indication for the location or asset of the ESL system based on the ESL notification request and the position information for the non-ESL device.

In a twenty-third aspect, a device for wireless communication comprises: at least one processor; and a memory coupled to the at least one processor, wherein the at least one processor is configured to cause the device to: receive, from an electronic shelf label (ESL) server, schedule information for ESL devices; receive, from the ESL server, schedule change information based on eTag transmission probability; transmit at least a portion of the schedule change information to one or more ESL devices; and transmit at least a portion of the schedule change information to one or more non-ESL devices.

In a twenty-fourth aspect, alone or in combination with one or more of the above aspects, the at least one processor is further configured to cause the device to: refrain from transmitting a downlink beacon start transmission based on the schedule change information.

In a twenty-fifth aspect, a device for wireless communication includes: at least one processor; and a memory coupled to the at least one processor, wherein the at least one processor is configured to cause the device to: receive, from an electronic shelf label (ESL) access point (AP), schedule information for ESL devices; receive, from the ESL AP, schedule change information based on eTag transmission probability; and transmit at least a portion of the schedule change information to one or more non-ESL devices.

In a twenty-sixth aspect, alone or in combination with one or more of the above aspects, the at least one processor is further configured to cause the device to: refrain from transmitting a downlink beacon transmission based on the schedule change information.

In a twenty-seventh aspect, alone or in combination with one or more of the above aspects, the at least one processor is further configured to cause the device to: perform a power save operation based on the schedule change information.

In a twenty-eighth aspect, a device for wireless communication includes: at least one processor; and a memory coupled to the at least one processor, wherein the at least one processor is configured to cause the device to: receive, from an electronic shelf label (ESL) device, schedule information for an ESL network; receive, from the ESL device, schedule change information based on eTag transmission probability; and transmit an uplink transmission based on the schedule change information.

In a twenty-ninth aspect, alone or in combination with twenty-eighth aspects, the at least one processor is further configured to cause the device to: perform a power save operation based on the schedule change information.

In a thirtieth aspect, alone or in combination with the twenty-eighth aspect or twenty-ninth aspect, the uplink transmission is an uplink beacon transmission for position determination operations or an ESL notification request.

Components, the functional blocks, and the modules described herein with respect to the figures described above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
transmit schedule information for electronic shelf label (ESL) devices;
determine eTag transmission probability based on an eTag charging time;
determine schedule change information based on the eTag transmission probability and the schedule information; and
transmit the schedule change information to one or more ESL devices, one or more non-ESL devices, or both.

2. The device of claim 1, wherein the schedule change information enables a power save operation for non-ESL devices, refraining from transmission of an ESL downlink beacon by an ESL device, or both.

3. The device of claim 1, wherein to transmit the schedule change information includes to:
transmit downlink schedule change information to the one or more ESL devices;
transmit uplink schedule change information to the one or more non-ESL devices; or
transmit combined uplink and downlink schedule change information to the one or more ESL devices, the one or more non-ESL devices or both.

4. The device of claim 3, wherein the uplink schedule change information is transmitted to the one or more non-ESL device via a cellular wireless network or via a local wireless network.

5. The device of claim 1, wherein the eTag transmission probability comprises a likelihood of transmission value and a confidence value, and wherein to determine to the schedule change information based includes to:
compare the likelihood of transmission value to a transmission probability threshold; and
compare the confidence value to a confidence value threshold, wherein the schedule change information is determined based on the likelihood of transmission value satisfying the transmission probability threshold and on the confidence value satisfying the confidence value threshold.

6. The device of claim 1, wherein to determine the eTag transmission probability includes to:
determine a first eTag transmission probability for a first eTag for a first uplink transmission time period, wherein the first uplink transmission time period is an uplink window or an uplink slot of the uplink window, and wherein the eTag transmission probability is based on the first eTag transmission probability.

7. The device of claim 6, wherein to determine the eTag transmission probability includes to:
determine a second eTag transmission probability for the first eTag for a second uplink transmission time period;
determine a third eTag transmission probability for a second eTag for the first uplink transmission time period; or
both, wherein the eTag transmission probability is based on the first eTag transmission probability and one or more of the second eTag transmission probability or the third eTag transmission probability.

8. The device of claim 6, wherein the first eTag transmission probability is associated with a particular region, and wherein the schedule change information includes one or more schedule changes for the particular region.

9. The device of claim 1, wherein to determine the eTag transmission probability includes to:
determine a first eTag transmission probability for a first eTag for a first uplink transmit resource opportunity, wherein the first uplink transmit resource opportunity includes a time resource, a frequency resource, a coding parameter, or a combination thereof, and wherein the eTag transmission probability is based on the first eTag transmission probability.

10. The device of claim 1, wherein the at least one processor is further configured to cause the device to:
determine a priority associated with a particular non-ESL device;
determine whether to provide an uplink grant for the particular non-ESL device based on the priority; and
generate the schedule change information including the uplink grant for the particular non-ESL device based on the priority and the eTag transmission probability.

11. The device of claim 10, wherein the priority is determined based on a transmission latency associated with the particular non-ESL device, a type of the particular non-ESL device, or both.

12. The device of claim 1, wherein the at least one processor is further configured to cause the device to:
determine a position associated with a particular non-ESL device;
determine a position or region associated with the eTag transmission probability;
determine whether to provide an uplink grant for the particular non-ESL device based on the position associated with the particular non-ESL device and the position or region associated with the eTag transmission probability; and
generate the schedule change information including the uplink grant for the particular non-ESL device based on a difference in the position associated with the particular non-ESL device and the position or region associated with the eTag transmission probability satisfying a distance threshold.

13. The device of claim 1, wherein the at least one processor is further configured to cause the device to:
determine a first group of ESL controllers of a plurality of ESL controllers of an ESL system associated with an eTag of the ESL system; and
determine a second group of ESL controllers of the plurality of ESL controllers of the ESL system associated with a non-ESL device of the ESL system, wherein the eTag transmission probability corresponds to a transmission probability for the eTag and the schedule change information indicates a schedule change for the first group of ESL controllers and for second non-ESL devices associated with the first group of ESL controllers.

14. The device of claim 13, wherein the at least one processor is further configured to cause the device to:
determine a third group of ESL controllers of the plurality of ESL controllers of the ESL system associated with the non-ESL device of the ESL system based on an overlap between the first group of ESL controllers and the second group of ESL controllers.

15. The device of claim 14, wherein the third group of ESL controllers is further determined based on priority associated with the non-ESL device, based on one a location of the ESL controllers of the second group of ESL controllers, a power parameter of the ESL controllers of the second group of ESL controllers, an amount of the ESL controllers of the first or second group of ESL controllers, or a position determination quality metric.

16. The device of claim 1, wherein the at least one processor is further configured to cause the device to:
determine to enable or disable scheduling adjustments based on a number of eTags, a number of non-ESL devices, or both.

17. The device of claim 1, wherein the eTag charging time corresponds to an anticipated eTag charging time based on a history of eTag charging times or eTag transmissions, and wherein to determine the eTag transmission probability includes to:
determine the eTag transmission probability based on the anticipated eTag charging time, an eTag backoff parameter, a number of eTags, and a probability threshold.

18. The device of claim 1, wherein the at least one processor is further configured to cause the device to:
receive measurement information for an eTag and associated with measurements of uplink beacons from the eTag; and
determine a position for the eTag based on the received measurement information.

19. The device of claim 1, wherein the at least one processor is further configured to cause the device to:
receive measurement information for a non-ESL device of the one or more non-ESL devices and associated with measurements of uplink beacons from the eTag, uplink beacons from the non-ESL device, or both; and
determine a position for the non-ESL device based on the received measurement information.

20. The device of claim 1, wherein the at least one processor is further configured to cause the device to:
receive position information for a non-ESL device of the one or more non-ESL devices and derived from measurements by the non-ESL device of downlink beacons from the one or more ESL devices.

21. The device of claim 1, wherein the at least one processor is further configured to cause the device to:
obtain position information for a non-ESL device of the one or more non-ESL devices based on an uplink transmission from the non-ESL device, the uplink transmission transmitted based on the schedule change information;
receive an ESL notification request from the non-ESL device indicating a request associated with a location or asset of an ESL system; and
transmit an ESL notification to the non-ESL device indicating the location or asset of the ESL system based on the ESL notification request and the position information for the non-ESL device.

22. The device of claim 21, wherein the at least one processor is further configured to cause the device to:
transmit an ESL notification to the one or more of the ESL devices and configured to cause the one or more ESL devices to output an indication for the location or asset of the ESL system based on the ESL notification request and the position information for the non-ESL device.

23. A device for wireless communication, comprising:
at least one processor; and
a memory coupled to the at least one processor,
wherein the at least one processor is configured to cause the device to:
receive, from an electronic shelf label (ESL) server, schedule information for ESL devices;
receive, from the ESL server, schedule change information based on eTag transmission probability;
transmit at least a portion of the schedule change information to one or more ESL devices; and
transmit at least a portion of the schedule change information to one or more non-ESL devices.

24. The device of claim 23, wherein the at least one processor is further configured to cause the device to:
refrain from transmitting a downlink beacon start transmission based on the schedule change information.

25. A device for wireless communication, comprising:
at least one processor; and
a memory coupled to the at least one processor,
wherein the at least one processor is configured to cause the device to:
receive, from an electronic shelf label (ESL) access point (AP), schedule information for ESL devices;
receive, from the ESL AP, schedule change information based on eTag transmission probability; and
transmit at least a portion of the schedule change information to one or more non-ESL devices.

26. The device of claim 25, wherein the at least one processor is further configured to cause the device to:
refrain from transmitting a downlink beacon transmission based on the schedule change information.

27. The device of claim 25, wherein the at least one processor is further configured to cause the device to:
perform a power save operation based on the schedule change information.

28. A device for wireless communication, comprising:
at least one processor; and
a memory coupled to the at least one processor,
wherein the at least one processor is configured to cause the device to:
receive, from an electronic shelf label (ESL) device, schedule information for an ESL network;
receive, from the ESL device, schedule change information based on eTag transmission probability; and
transmit an uplink transmission based on the schedule change information.

29. The device of claim 28, wherein the at least one processor is further configured to cause the device to:
perform a power save operation based on the schedule change information.

30. The device of claim 28, wherein the uplink transmission is an uplink beacon transmission for position determination operations or an ESL notification request.
